(19) United States
(12) Patent Application Publication
(10) Pub. No.: US 2024/0403776 A1
(43) Pub. Date: Dec. 5, 2024

(54) MACHINE LEARNING-BASED RESOURCE PREDICTION AND OPTIMIZATION

(71) Applicant: C3.ai, Inc., Redwood City, CA (US)

(72) Inventors: Varun Badrinath Krishna, Hayward, CA (US); Burton Mayer, San Francisco, CA (US); Christian Giovanelli, New York, NY (US); David Michael Schmaier, Atherton, CA (US); Ivan Robles Munoz, London (GB); Naoufal Layad, Redwood City, CA (US); Saikiran Maddela, Foster City, CA (US); Ye Chan Kim, Emerald Hills, CA (US)

(73) Assignee: C3.ai, Inc., Redwood City, CA (US)

(21) Appl. No.: 18/731,279

(22) Filed: Jun. 1, 2024

Related U.S. Application Data
(60) Provisional application No. 63/505,680, filed on Jun. 1, 2023.

(51) Int. Cl. G06Q 10/0637

(52) U.S. Cl. CPC G06Q 10/06375

(57) ABSTRACT

Aspects of this disclosure are directed to enterprise systems and methods that provide machine learning and artificial intelligence (AI) driven software that generates baseline predictions and optimizations for production capacity to reduce waste and harmful byproducts. Baseline predictions can include resource baseline predictions that can help estimate (or, predict) how much lower or higher an asset's resource inputs (e.g., fuel) and/or outputs (e.g., emissions) could be in comparison to the asset's current resource inputs and/or outputs. AI generated baseline predictions can be broken down into several different levels (e.g., facility level down to the asset level) so that it is clear where the most significant opportunities for resource savings lie, and the system can perform optimizations (e.g., trigger corrective actions) to achieve those resource savings.

### CROSS-REFERENCE TO RELATED APPLICATIONS

The present application claims the benefit of U.S. Provisional Patent Application Ser. 63/505,680, filed Jun. 1, 2023, and entitled “Machine Learning-based Resource Prediction and Optimization,” which is hereby incorporated by reference herein.

### TECHNICAL FIELD

This disclosure pertains to artificial intelligence and machine learning optimization solutions. More specifically, this disclosure pertains to enterprise systems and methods for machine learning-based resource prediction and optimization.

### BACKGROUND

Under traditional approaches, computing systems are unable to quantify resource reduction potential (or gap to reduction potential) based on historical performance under different scenarios, or otherwise. Traditional computing systems are also unable to automatically or accurately identify drivers that correlate with resource outputs (e.g., greenhouse gas emissions). Traditional computing systems are incapable of scaling resource optimization approaches across many different facilities (e.g., factories) that may each contain many different assets (e.g., physical equipment).

### BRIEF DESCRIPTION OF THE DRAWINGS

FIG. 1 depicts a diagram of an example network system for machine learning-based resource prediction and optimization according to some embodiments.

FIG. F 2 depicts a diagram of an example system flow of a machine learning-based resource prediction and optimization system using hierarchical aggregation to generate accurate results at the facility level when there are different types of assets and/or dependencies according to some embodiments.

FIG. 3 depicts a diagram of an example machine learning-based resource prediction and optimization system according to some embodiments.

FIG. 4 depicts a diagram of an example system architecture and flow (e.g., of a machine learning-based resource prediction and optimization system and/or forecasting module) integrating Temporal Fusion Transformers (TFT) into the machine learning processes of a machine learning-based resource prediction and optimization system according to some embodiments.

FIG. 5A depicts a flowchart of an example of a method of resource baseline prediction according to some embodiments.

FIG. 5B depicts a flowchart of an example of a method of adjusting an asset based on predicted values and threshold values according to some embodiments.

FIG. 5C depicts a flowchart of an example of a method of artificial intelligence-driven forecasting according to some embodiments.

FIG. 5D depicts a flowchart of an example of a method of cohort baseline prediction according to some embodiments.

FIG. 6 depicts a flowchart of an example of a method of cohort baseline prediction according to some embodiments.

FIG. 7 depicts a flowchart of an example of a method of generative artificial intelligence-based resource baseline prediction according to some embodiments.

FIG. 8 depicts a diagram of an example method of machine learning-based resource prediction and optimization at the facility-level according to some embodiments.

FIG. 9 depicts a flowchart of an example of a method of training a machine learning model for resource baseline prediction according to some embodiments.

FIG. 10 depicts a flowchart of an example of a method of hierarchical aggregation to generate accurate results at the facility level when there are different types of assets and/or dependencies according to some embodiments.

FIG. 11 depicts a flowchart of an example of a method of generative artificial intelligence-based resource prediction and optimization according to some embodiments.

FIG. 12A depicts a diagram of example cohort baselining pipelines according to some embodiments.

FIG. 12B depicts a diagram of example system flow and output that uses machine learning-predicted target (e.g., ideal/optimal) baseline for asset performance benchmarking relative to asset peers.

FIG. 13 depicts a flowchart of an example of a method of operation of an orchestrator module according to some embodiments.

FIG. 14 is a diagram of an example computer system for implementing the features disclosed herein according to some embodiments.

### DETAILED DESCRIPTION

Managing and mitigating resource consumption is a top priority across the world. Exacerbating the situation, organizations often cannot accurately calculate the resources that they consume (e.g., fuel) or byproducts generated (e.g., emissions), let alone determine how to improve the efficiency of their operations to reduce the amount of resources consumed and produced. For example, an organization (e.g., enterprise) may have many different facilities (e.g., factories) spread across several different continents, and each of the factories may consume and produce an indeterminate amount of resources. Each of the factories may also include many different assets (e.g., physical equipment, such as furnaces), and each of those assets may also individually consume and produce an indeterminate amount of resources and byproducts. The systems and methods described herein can not only accurately track the amount of resources consumed and byproducts produced, but they also provide analytics and artificial intelligence insights that can accurately predict how to improve the efficiency of their operations and reduce resource consumption and byproduct generation. Moreover, the systems and methods described herein can do this at the organizational level, the facility level, all the way down to the individual asset level. For example, the systems and methods described herein can (1) determine an overall resource consumption and production of organizations, factories, and assets, (2) determine which factories and assets are inefficient, (3) diagnose the issues causing the inefficiencies, and (4) recommend and/or perform corrective actions (e.g., modifying configurations of factories or assets) to bring them to optimal or acceptable levels.

In one example, a computing system provides artificial intelligence-driven software application baseline predictions to determine expected and optimal resource utilization (e.g., consumption, production) for organizations, factories, and assets. Expected resource utilization can include predicted values indicating the amount of resources a facility or asset should consume or amount of byproducts generated based on the data (e.g., time series data) of that facility or asset. For example, given feed rates, a type of fuel used by an asset, and tensor encapsulating other measured operating conditions in real time such as sensors measuring temperature, pressure, speed, etc. the artificial intelligence software application can predict the amount of resources that the asset should consume or the amount of byproducts that should be generated under current conditions. Optimal resource utilization can include predicted values indicating a maximum efficiency (e.g., based on a predicted lowest amount of resource consumption or production) of a facility or asset based on the data of that facility or asset. These baseline predictions can help estimate (or, predict) how much lower resource outputs (e.g., emissions) in comparison to current resource outputs via analysis of the asset's tensor of operating condition measurements during a specified baseline period when the asset was performing well or as intended (such as directly after maintenance or using a fuel type with higher conversion efficiency or lower carbon weight). Selection of the baseline period defines the benchmark scenario represented by the prediction series. Baseline predictions, as well as the other predictions discussed herein, can be provided at several different levels of granularity (e.g., organizational, facility, asset) so that it is clear where the most significant opportunities for resource savings lie across a massive hierarchy of assets. This approach enables rapid prioritization of opportunities across global operations-which is intractable using manual methods which do not consider the massive collection of tensors signifying each asset's operating conditions over time and space.

Example aspects include machine learning based predictions to compare resource inputs and outputs at all levels of a facility against baseline predictions to perform resource optimizations over time. The predictions provide resource savings opportunities, such as where fuel consumption and greenhouse gas emissions can be reduced. Resource predictions can be directed to resources such as greenhouse gases, combusted fossil fuels, waste, compressed air, and derived resources, among others. An example aspect includes hierarchical aggregations for its forecasts, from individual assets up to the facility level, allowing more accurate forecasts than a non-hierarchical solution. The hierarchical aggregation capability reinforces in-depth analysis across levels from asset to entire facility. It enables a powerful level of accuracy to address output efficiency concerns in a novel and adaptive ways that traditional approaches fail at by summing outputs and inputs of the facility assets. This multi-level capability, combined with the machine learning prediction capabilities for outputs includes inspection and explainability of the analysis to drill down from facility to individual assets of interest to provide new and robust predictions.

The computing system provides artificial intelligence-driven cohort baseline predictions to determine ideal performance (e.g., resource consumption, resource production, efficiency) of facilities and assets relative to peer facilities and assets. Each ideal value in the prediction series may be the optimum (e.g., typically minimum or maximum; aggregation function depends on target variable) of inferred expected values across all peer assets in the cohort for a single tensor of asset operating conditions representing the studied asset's state at a particular timestamp. This can provide enhanced opportunity identification because predictions for various facilities or assets can be biased by the data of those facilities and assets. For example, a particular asset may be operating efficiently based on the expected baseline prediction for that asset, but that efficiency may not tell whole the story. For example, the asset may be located in one area of a facility and another asset of the same type may be located in another area of the facility or feature recently retrofitted components of superior design and quality. By performing a cohort analysis, the computing system may determine that the given asset is actually inefficient relative to its peers while it is relatively efficient when compared to its own baseline period which can be due to the location of the asset in the factory or lack of retrofitted parts rather than some problem with the asset itself. Detection of these discrepancies across assets is enabled via operationally-aware benchmarking across both time and space—automatically benchmarking across the potentially high dimensional vector space of operating conditions among peer assets within an expertly or automatically defined cohort via clustering. Accordingly, by reducing asset-specific bias, the computing system can greatly increase system accuracy in detecting performance issues and outliers (e.g., increase comprehensiveness of optimization recommendations).

As described herein, the artificial intelligence-driven baseline predictions provide organizations and facilities greater insight into where outlier sources of waste are while the detailed system optimizes assets to try to maintain an efficient output baseline. Example implementations focusing on managing resources (e.g., harmful resources) provides a narrowing to its prediction that aids in solving previously addressable problems with a long felt need from the industry. The novel systems and techniques disclosed herein provides benefit to improve efficiency and optimization of how much production capacity can be fit inside waste limits. This not only improves yield and cost savings but also has positive environmental benefits. AI based predictions can provide recommendations in real-time to generate a time-series of control actions or adjustments to optimize large scale operations that have a multitude of assets across a multiple facilities.

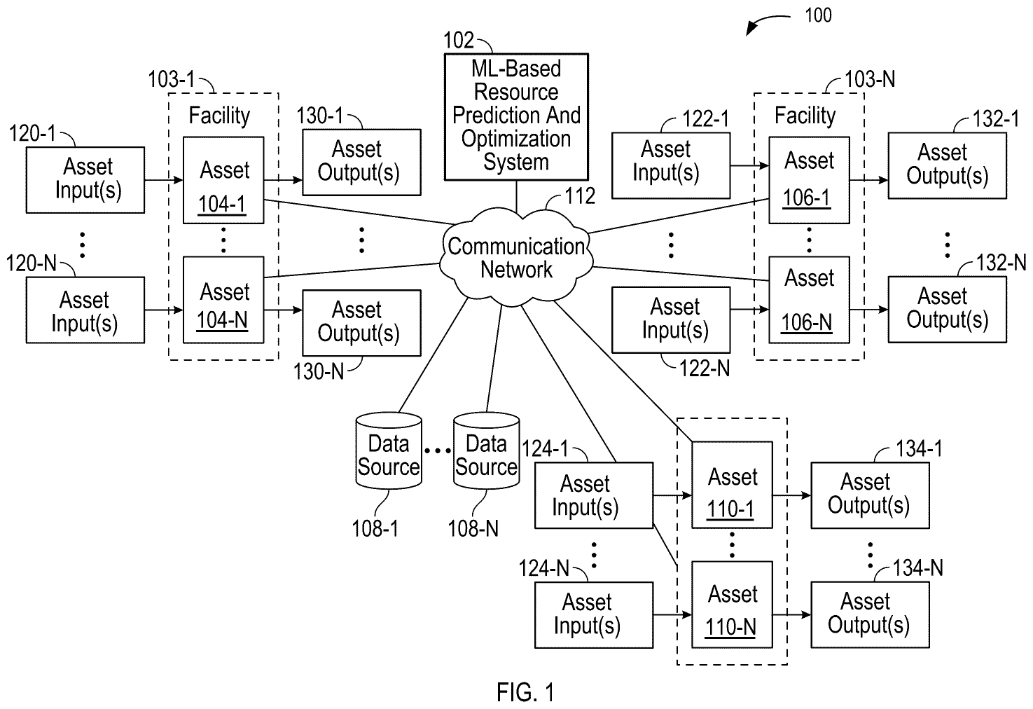

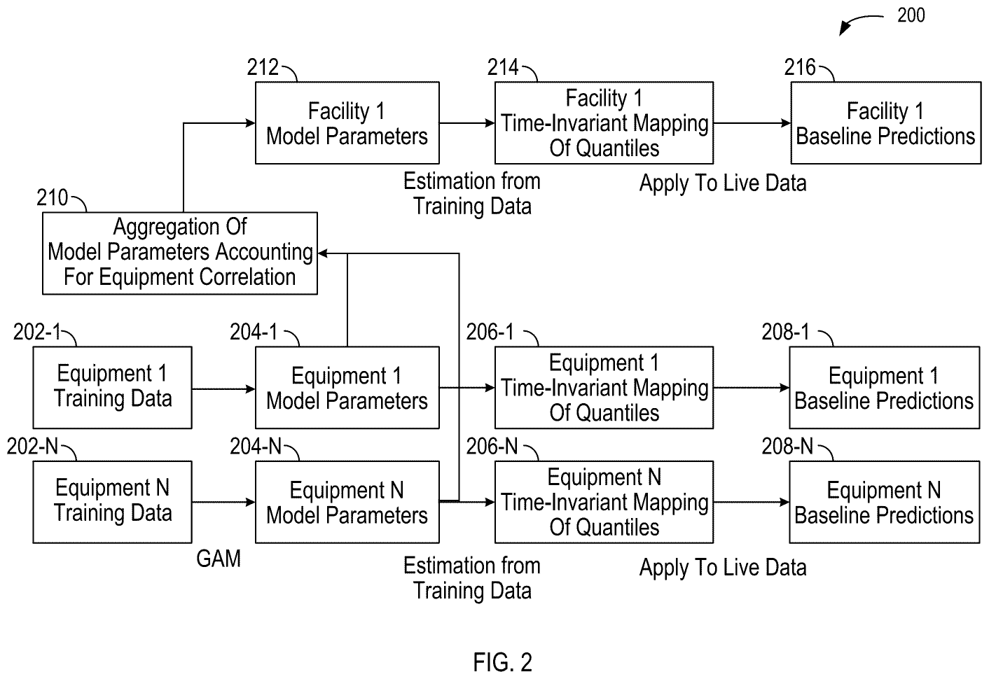

FIG. 1 depicts a diagram 100 of an example network system for machine learning-based resource prediction and optimization according to some embodiments. In the example of FIG. 1, the system includes a machine learning-based resource prediction and optimization system 102, facilities 103-1 to 103-N (individually, the facility 103, collectively, the facilities 103), assets 104-1 to 104-N (individually, the asset 104, collectively, the assets 104), assets 106-1 to 106-N (individually, the asset 106, collectively, the assets 106), data sources 108-1 to 108-N (individually, the data source 108, collectively, the data sources 108), assets 110-1 to 110-N (individually, the asset 110, collectively, the assets 110), and a communication network 112.

The machine learning-based resource prediction and optimization system 102 may function to predict resource baseline variable values for the target variable conveying asset performance (or, simply, resource baseline values) and predict cohort resource baseline values for assets 104, 106, 110 and facilities 103, to accurately determine resource utilization and operational efficiency at the organizational level, the facility level, and the asset level. The machine learning-based resource prediction and optimization system 102 may facilitate an increase or reduction of many different resources, byproducts, and associated financial costs in the real world or in a simulated environment. For example, the machine learning-based resource prediction and optimization system 102 may recommend or perform (e.g., trigger) corrective setpoint modifications actions based on the baseline predictions to ensure that associated assets are operating at an optimal or acceptable level and performance is maximized (e.g., in terms of emissions and costs reduction). In various embodiments, functionality of the machine learning-based resource prediction and optimization system 102 may be performed by one or more servers (e.g., a cloud-based server) and/or other computing devices. In some implementations, the machine learning-based resource prediction and optimization system 102 may be implemented using a model-driven architecture. Software performance (e.g., speed and latency of the system) is enhanced by exploiting parallelism across traditional servers and/or cores within allocated and virtualized accelerators, properly distributing inference workloads when the number of peer assets, and in turn, the number of models associated with each asset's cohort becomes relatively high.

The facilities 103 may be a part of an organization, and they may each include a variety of different assets 104-106. Assets may also be outside of an organization and/or facility (e.g., the assets 110). Such assets may be weather service assets and/or other third-party assets. Assets can include equipment, sensors in the one or more facilities, sensors associated with equipment, sensors outside a facility (e.g., sensors collecting weather data), and the like. Assets 104-106 and 110 can include (or, represent) physical assets (e.g., a physical piece of equipment, such as a generator) and/or virtual assets (e.g., an electronic or virtual representation of a piece of equipment or sensor). As used herein, sensors can include, for example, temperature sensors, pressure sensors, speed sensors, rotation sensors, and/or other sensors. Asset sensor data—the majority of which is not resource consumption measurements, but operational measurements as described above—is the most important data source informing baseline predictions, which are typically not incorporated fully, if at all, in status quo methods nor competing solutions lacking large scale ML analysis.

The assets 104-106 and 110 can use (e.g., consume) asset inputs 120-1 . . . 120-N and produce asset outputs (or, simply, “outputs”) 130-1 . . . 130-N. For example, asset inputs and output can include physical quantities (e.g., fuel, greenhouse gas emissions), virtual quantities (e.g., simulated fuel, simulated greenhouse gas emissions), and/or other types of sustainability or operational performance indicators. Asset inputs, outputs, and other performance indicators may be individually or collectively referred to as a “KPI” or “KPIs.”

Outputs can include, but are not limited to products, coproducts, and byproducts. Byproducts such as GHG emissions can be automatically quantified in real-time using primary or secondary process activity data (e.g. sensor data, resource consumption data), direct measurement (e.g. directly measured pollutant gas concentrations and flue gas flow by a CEMS or analogous system), mass balance (e.g. computed difference between carbon inputs and outputs across plant's operational boundary) or industry or sector specific models incorporating asset and process specific operational parameters, conversion factors, and formulae. In some embodiments, byproducts are a type of resource.

The assets 106 of the facility 103 can use (e.g., consume) asset inputs 122-1 . . . 122-N and produce outputs 132-1 . . . 132-N. For example, asset inputs and output can include physical quantities (e.g., fuel, greenhouse gas emissions), virtual quantities (e.g., simulated fuel, simulated greenhouse gas emissions), and/or other types of sustainability or operational performance indicators. The assets 110-1 . . . 110-N represent assets located outside of a facility. For example, assets 110 can weather service sensors, third-party sensors, etc. The assets 110 can consume asset inputs 124-1 . . . 124-N and produce outputs 134-1 . . . 134-N.

Resources can include different types of physical and/or virtual resources. For example, resources can include/represent physical or virtual greenhouse gas emissions and/or other types of emissions, electricity consumption/generation, fuels (e.g., combusted and non-combusted fuels), nonfuel hydrocarbon consumption (e.g., feedstock usage of natural gas, other hydrocarbons, etc.), water, waste, compressed air, purchased steam, and/or other types of resource inputs or resource outputs.

In some embodiments, resources may include derived resources (e.g., efficiency). In the example of derived resources, the machine learning-based resource prediction and optimization system 102 can perform predictions indirectly or directly. For example, an indirect prediction may include determining a target KPI's (e.g., emissions) baseline and computing an efficiency baseline as throughput divided by the KPI's baseline. Alternatively, a direct prediction may directly baseline efficiency based on one or more machine learning models learning what efficiency should be under different scenarios and operating conditions. It will be appreciated that there may be many different types of derived resources (e.g., of which emissions may be one) that can be baselined either directly or indirectly.

In some embodiments, asset inputs and/or asset outputs can include resources. In some embodiments, the machine learning-based resource prediction and optimization system 102 may use and obtain data from many different data sources 108 and types of data sources. For example, the machine learning-based resource prediction and optimization system 102 may obtain data indicating the gas composition of a mixture (e.g., broken down by component). The mixture may be a resource input to various assets, such as generators. The data may also indicate fluid flow, asset outputs (e.g., generator outputs), other asset inputs, the heat of combustion, operating conditions, ambient conditions (e.g., temperature, humidity, precipitation, solar irradiance, wind speed, etc.), production schedules, utility usage, maintenance events, work orders, satellite imagery, and/or other sensor data (e.g., from third-party sensors).

Some or all of this data may comprise sensor data, and the sensors may comprise assets or be associated with assets (e.g., associated with particular equipment). Operating conditions can include, for example, discharge pressure and temperature, suction pressure and temperature, compressor power, schedule of facility-level or equipment-level maintenance activities or shutdowns, number of types of assets, the states of various assets, and the like. Any subset of this data can be used as model input features (or, simply, model inputs) directly or as input to more sophisticated feature engineering methods.

The machine learning-based resource prediction and optimization system 102 can provide artificial intelligence-driven baseline predictions. For example, the machine learning-based resource prediction and optimization system 102 can predict how particular assets should operate (e.g., the amount of emissions they should produce) given various conditions (e.g., current conditions, historical conditions, simulated conditions). The conditions may include some or all of the data (including operating conditions) discussed above. In some implementations, machine learning-based resource prediction and optimization systems can generate estimates of what resources could have been in the past, given current conditions. Baseline predictions can be configured to predict different baselines, such as an average-case resource baseline, best-case resource baseline, and/or worst-case resource baseline across time and/or space (cohort of peer assets). The data may be represented by time series data over various periods.

The communications network 112 may represent one or more computer networks (e.g., LAN, WAN, or the like) or other transmission mediums. The communication network 112 may provide communication between the systems, engines, datastores, distributed compute and storage resources, and/or the like, described herein. In some embodiments, the communication network 112 includes one or more computing devices, routers, cables, buses, and/or other network topologies (e.g., mesh, and the like). In some embodiments, the communication network 112 may be wired and/or wireless. In various embodiments, the communication network 112 may include the Internet, one or more wide area networks (WANs) or local area networks (LANs), one or more networks that may be public, private, IP-based, non-IP based, and so forth.

FIG. 2 depicts a diagram 200 of an example system flow of a machine learning-based resource prediction and optimization system 102 using hierarchical aggregation to generate accurate results at the facility level when there are different types of assets and/or dependencies according to some embodiments.

In some implementations, the machine learning-based resource prediction and optimization system 102 performs hierarchical aggregation of AI-based forecasts and baselines. This can be particularly useful when calculating/predicting resource outputs/inputs at a facility level. More specifically, the accurate results cannot typically be obtained by merely summing the resource outputs/inputs unless the facility only has one type of asset and there are no dependencies between assets. For example, if there are different assets with dependencies with each other, summing the resource inputs/outputs would produce inaccurate results because some inputs/outputs may be “double-counted.” Accordingly, the machine learning-based resource prediction and optimization system 102 may use flexible hierarchical aggregation to produce accurate results at the facility level when there are different types and levels of assets and/or dependencies. An asset's baseline can be defined as an aggregation of its child assets' baselines. In this case, the union of features across child assets' baseline models can be included in feature contribution explanations of AI baselines, and contribution values can be aggregated via weighting by child asset's target KPI magnitude over a selected period. For example, a customer may want to baseline performance for a front-end process area which does not have any sensors directly associated with it and thus define the process area baseline as the sum of baselines across disjoint child machines located within the area.

In some implementations, artificial intelligence models of the machine learning-based resource prediction and optimization system 102 can be applied directly at any level of the customer's hierarchy (e.g., facility, business unit, system, subsystem, sensor, etc.). Model outputs can be aggregated up to higher levels (e.g., plant, business unit, and enterprise levels). This approach can require fewer models (e.g., no need for models at the higher levels of aggregation). If a probabilistic approach is used, then the aggregation can leverage the properties of the underlying distributions. Some distributions (e.g., Gaussian) can be summed up from a lower level (e.g., sensor) to a higher level (e.g., facility) while still having the same distribution type, but the parameters will change. The aggregation pays attention to whether the lower-lever distributions are independent or not. For example, if two assets (e.g., two pieces of equipment) have correlated resource outputs (e.g., greenhouse gas emissions), then their correlation can be factored in when estimating the aggregated resource output for the facility.

In one example, the aggregation can involve model parameter estimation at the asset level (e.g., equipment level), parameter aggregation to the facility level and time-invariant mapping of quantiles (e.g., expressed as a function of the model parameters) applied separately at the asset (e.g., equipment) and facility levels (e.g., as shown in FIG. 2). The aggregation from sensors to facility can be reframed as a disaggregation from facility to sensor in terms of end-user workflows.

In the example of FIG. 2, the machine learning-based resource prediction and optimization system 102 obtains training data specific to different assets (e.g., equipment) of a facility in steps 202-1 to 202-N. In steps 204-1 to 204-N, the machine learning-based resource prediction and optimization system 102 estimates model parameters from the training data. In step 206-1 to 206-N, the machine learning-based resource prediction and optimization system 102 determines time invariant mappings of quantiles for each of the equipment and applies that to live (e.g., real-time) data to predict baseline resource predictions for each equipment in steps 208-1 to 208-N. In step 210, the machine learning-based resource prediction and optimization system 102 aggregates the model parameters accounting for equipment correlation to estimate the facility model parameters from the training data in step 212. In step 214, the machine learning-based resource prediction and optimization system 102 determines the time-invariant mapping of quantiles and applies to live data to determine baseline predictions for the entire facility in step 216.

Quantiles may be selected by a variety of different methods, such as probabilistic methods and quantile regression methods. In some embodiments, the machine learning-based resource prediction and optimization system 102 can build a Bayesian probabilistic GAM model, since this avoids quantile crossover and allows the system 102 to aggregate predictions from equipment level to facility level. Pygam implementation can also be used to allow the system 102 to construct a B-spline GAM which predicts mean and variance (this variance may be dependent on features).

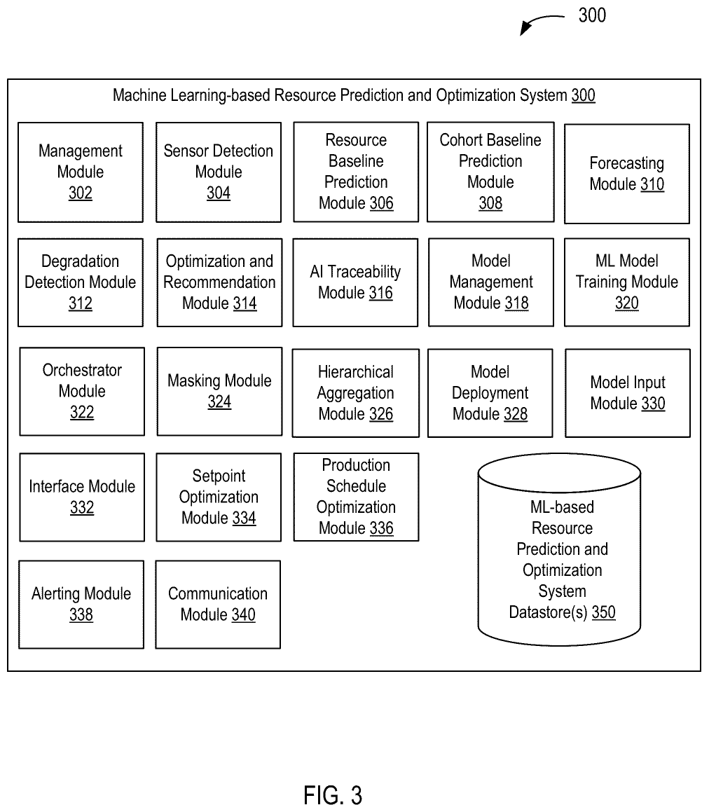

FIG. 3 depicts a diagram 300 of an example of a machine learning-based resource prediction and optimization system 102 according to some embodiments. In the example of FIG. 3, the machine learning-based resource prediction and optimization system 102 includes a management module 302, a sensor detection module 304, a resource baseline prediction module 306, a cohort baseline prediction module 308, a forecasting module 310, a degradation detection module 312, an optimization module and recommendation module 314, an artificial intelligence traceability module 316, a model management module 318, a machine learning model training module 320, an orchestrator module 322, a masking module 324, a hierarchical aggregation module 326, a model deployment module 328, a model input module 330, an interface module 332, a setpoint optimization module 334, a production schedule optimization module 336, an alerting module 338, a communication module 340, and a machine learning-based resource prediction and optimization system datastore 350.

The management module 302 can function to manage (e.g., create, read, update, delete, or otherwise access) data associated with the machine learning-based resource prediction and optimization system 102. The management module 302 can manage some or all of the of the datastores described herein (e.g., machine learning-based resource prediction and optimization system datastore 350, data sources 108) and/or in one or more other local and/or remote datastores. It will be appreciated that datastores can be a single or multiple datastore local to the machine learning-based resource prediction and optimization system 102 and/or single or multiple datastores remote from the machine learning-based resource prediction and optimization system 102. The datastores described herein can comprise one or more local and/or remote datastores. The management module 302 can perform operations manually (e.g., by a user interacting with a GUI) and/or automatically (e.g., triggered by one or more of the modules 304-340). Like other modules described herein, some or all the functionality of the management module 302 can be included in and/or cooperate with one or more other modules, services, systems, and/or datastores.

In some embodiments, the management module 302 can manage, integrate, and/or normalize disparate data from disparate data sources. For example, the management module 302 can integrate asset data, utility data, production schedule data, facility, third-party data (e.g., weather service data), and the like. The data can include historical data, real-time or live data, time series data, etc. The management module 302 may use predefined integration rules to integrate some or all of the data described herein.

The sensor detection module 304 can function to detect actual (e.g., current, real-time, live, etc.) sensor values. The sensor values may be detected directly from the assets, facilities, and/or third-party services and assets (e.g., by monitoring sensors of the assets, factories, and/or third-party services and assets. The sensor detection module 304 may detect time series data and include timestamps and/or metadata in the time series data.

The resource baseline prediction module 306 can function to resource baseline values for organizations (e.g., groups of facilities and/or assets). The resource baseline prediction module 306 can predict expected resource baseline values and optimal (or, ideal) resource baseline values. The predicted resource baseline values may correspond to expected resource consumption and optimal resource consumption of the asset. The predicted resource baseline values may correspond to expected resource production (or, output) and optimal resource production. As used herein, “optimal” may be determined based on one or more rules and/or threshold. For example, an operating manual or specification of an asset may indicate the optimal values for that asset. The optimal values may also be determined using machine learning. For example, machine learning models may be used to take model outputs associated with various assets over a period time and determine that the top 5% (e.g., top 5% more efficient) of those assets represent the optimal values for that that asset based upon its current vector of operating conditions.

In some implementations, the resource baseline prediction module 306 can make predictions using one or more machine learning models. Outputs of the machine learning models can be applied to various resources of interest, including any of the resources described herein. Machine learning inputs (e.g., features), can be used by the models to learn the baselines. The features may be directly based on data described herein, and/or transformations of that data.

It will be appreciated that the exact implementation of baseline predictions may vary and may depend on how many models are used and how they are trained. Additionally, baseline values can be estimated at any resolution (e.g., hourly, daily, monthly), and can be applied at the organization level (e.g., one or more facilities) or any finer-grained level (e.g., facility level and/or asset level).

Various models are available for baselining (e.g., resource and cohort baselining), and may be used by the resource baseline prediction module 306, the cohort baseline prediction module 308, the forecasting module 310, the optimization and recommendation module 314, and/or other modules described herein. The models may include linear regression models, tree-based models (e.g., GBMs, RF, Decision Tree) and GAMs (generalized additive model), and temporal fusion transformers (TFTs). In some examples GAMs may be preferred because they (1) can extrapolate, which tree-based models typically cannot do, (2) can model nonlinear dependencies, which linear models cannot do, and (3) offer comparable performance to GBMs.

In some implementations, once the model is deployed, the baseline predictions are expected to deviate from the actual measurements. However, resource baseline prediction module 306 needs to understand if this is due to the model failing due to data drift or if the equipment behavior is changing. In one example, the resource baseline prediction module 306 can select a reference period for the baseline. The goal of the baseline model is to compare current performance to historical performance. Over time, the dependencies between the target variable that is being baselined, and the features used to describe it change (e.g., this may be referred to as concept drift). The resource baseline prediction module 306 can model this change with an interaction effect between time and the features. There are multiple ways the resource baseline prediction module 306 can accomplish this task, such as (1) nonlinear surface interaction term between time and feature, (2) linear surface interaction term between time and feature, and (3) time as a term in the model. Each one of these options offers a tradeoff between overfitting and accuracy, and the last option can be used to model the concept drift. Once the resource baseline prediction module 306 has included this time term in the model, the resource baseline prediction module 306 can choose a time t that can be baselined against. This can allow, for example, the resource baseline prediction module 306 to specifically compare current performance to a given point in time.

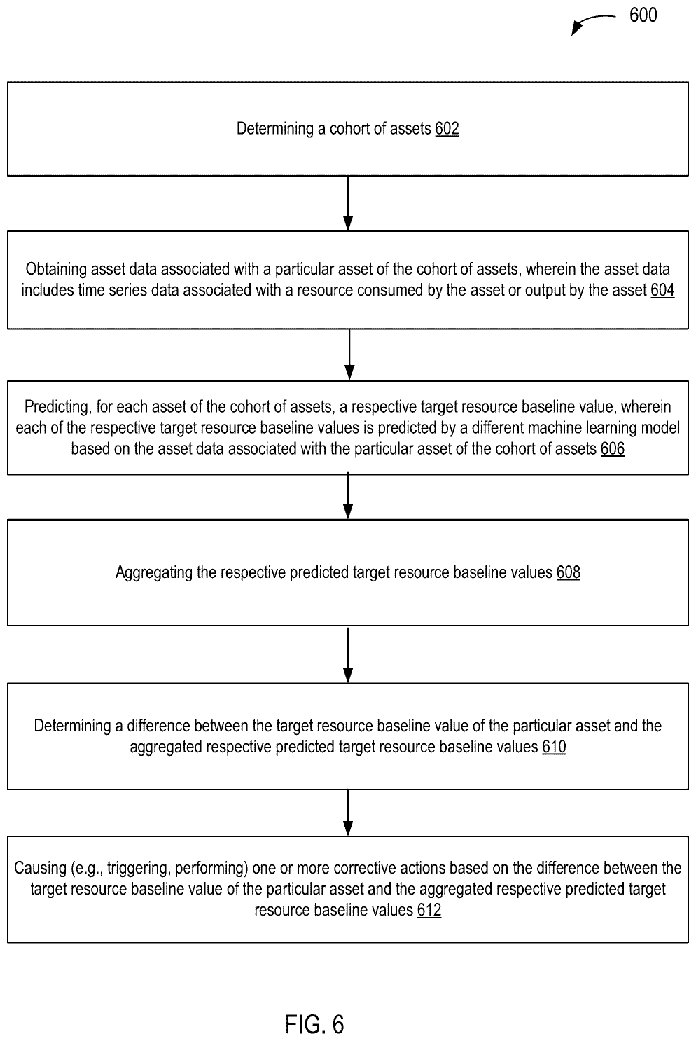

The cohort baseline prediction module 308 can function to evaluate or grade facilities and/or assets in relation to a cohort, wherein the cohort can include similar facilities and/or assets. For example, the types of assets in a cohort can include equipment, machines, etc. In some implementations, the cohort can be homogenous in that all assets are equipment and equipment are not being compared with facilities. The comparisons in a cohort can provide additional insight into relative performance metrics (e.g., efficiency, emissions, emissions intensity, etc.). Cohorts can be specified either manually or automatically. Automatic cohort identification can leverage AI, such as clustering or nearest neighbors. Attributes of assets (such as age, type, throughput, location, operating characteristics, etc.) can be used in automatically determining cohorts. In some implementations, end users may specify which attributes are to be used in automatically creating cohorts. An example method of cohort baseline prediction is shown in FIG. 6.

The forecasting module 310 can function to provide AI-driven forecasting. Forecasting can include predicting future resource inputs (e.g., fuel consumption), and future resource or byproduct outputs (e.g., greenhouse gas emissions). In the most common case, the forecasting module can leverage historical and future time series data (e.g., such as large tensors of asset telemetry data and/or historical and forecasted weather and climate data automatically ingested from third party APIs or additional meteorological instruments integrated directly into the system) and temporalized historical and future categorical data—such as production schedule data, operator shift data signaling relative expertise and productivity of each operator manning the production equipment, product properties (providing the system with signals and knowledge of the relative energy intensity of each SKU) documented in tabular ERP system, BoMs, recipes, and/or formulas—to forecast energy demand over a relevant lookahead window (e.g. 24 hours, 48 hours, etc.). The temporal fusion transformer architecture enables nonlinear generalization from all of these various types of data sources This system can anticipate in real time peaks in demand and calculate the financial costs of utility tariffs (via encoding and consolidation of utility rate structures, such as any time of use, capacity, tiered rates or real-time pricing into the system's unified knowledge base) and/or curtailments that will be incurred. Then, the system can shave those peaks, using the setpoint optimization module 334, by modifying allocation of distributed energy supplies, also referred to as execution of load balancing techniques (e.g., shifting allocations of energy supplies provided via onsite generators, storage systems, etc. during peak periods). If there are no distributed energy supplies connected to the system, to shave peaks in forecasted energy demand, the Production Schedule Optimization Module can not only shift production to different times of day for batch processes or batch-continuous processes, but also modify the product mix for high volume process which have little or no downtime, swapping energy intensive products for less energy intensive products in the schedule during forecasted peaks.

Another high-value use case facilitated by the forecasting module is forecasting emissions to mitigate compliance violation fines and carbon prices. For example, an industrial enterprise can leverage the forecasting module to forecast emissions over a lookahead window. When emissions exceed regulatory compliance threshold(s) or forecasted procured energy demand coincides with high utility demand and carbon-intensive peak load energy generation by the utility, the setpoint optimization module 334 and/or production schedule optimization module 336 can similarly shift allocation of energy supplies or production schedule(s) to mitigate violation of regulatory emissions rate thresholds, local demand peaks for the utility, and carbon-intensive peak load generation periods by the utility. By mitigating regulatory emissions threshold violations and scope 2 emissions from purchased energy, the industrial enterprise can reduce carbon costs required by local, regional, national, international carbon prices and broader GHG emissions price mechanisms. If necessary to facilitate necessary approval processes and permissions, these optimization steps can be implemented in an open loop workflow (as opposed to automatic adjustments implemented by a closed loop version of the system) included in the interface module, which persists recorded actions in the centralized data store, such that the alerting module notifies users of optimized setpoints and production schedules generated from these optimization modules periodically, or when peaks are detected via the forecasting module's output. Users will be able to visualize these optimization results (e.g., recommended, optimal asset setpoints and/or production schedules) in the AI application via the interface module. Emissions forecasts generated by the forecasting module can also empower enterprise to tactically reach their internal and external decarbonization targets across time and space and generate detailed decarbonization plans in near real time. Forecasts can infer (e.g., by leveraging data describing historically implemented and planned conservation projects and measures) whether decarbonization and other sustainability targets will be met by the intended date with knowledge of the current roadmap of planned projects and measures. The alerting module 338 can detect in real-time from periodically inferred emissions forecasts, when corporate, product, organization, or asset-level emissions or other performance targets are not expected to be satisfied, and the recommendations module can prioritize a collection of opportunities, minimizing a loss function that includes predicted implementation cost and expected emissions reduction impact for each opportunity or potential project. The results from the optimization and recommendation module 314 can be visualized in a metadata-driven, domain-specific UI component set within the interface module. Specifically, a marginal abatement cost curve (MACC) comprised of aggregated AI-identified conservation opportunities across time and space (e.g., hierarchy of assets, energy sources, etc.) prioritized by the aforementioned loss function—enables rapid collaboration between historically fragmented sustainability and operations organizations through further case management, sustainability project planning, and work order workflows within the AI application. Example implementations include the machine learning-based resource prediction and optimization system 102 providing aggregation and disaggregation of artificial intelligence results. More specifically, results from some or all of the artificial intelligence models (e.g., machine learning models, statistical models, large language models) described herein can be disaggregated. This can, for example, allow a machine learning-based resource prediction and optimization system to break down resource estimates for a facility to estimates from individual assets of the facility.

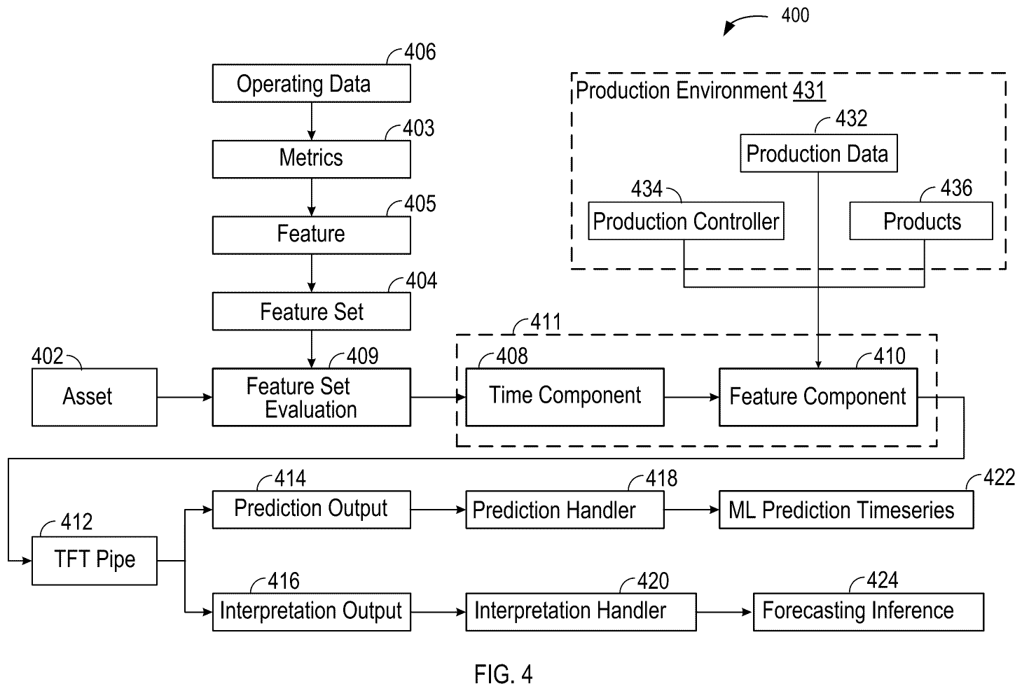

In some implementations, the default forecast module system architecture integrates the TFT into a ML workflow within a model driven architecture, as shown in FIG. 4. Feature sets can be evaluated to materialize the corresponding time series data typically from asset sensor historians, MES, or utility usage meters and bills. Preprocessing occurs through Lambda Pipes, indicating a preparation of time-based data and feature engineering. The TFT model operates on this prepared data to forecast future power usage, yielding predictions and their interpretations. These results are conveyed to downstream post-processes, which are done by prediction handler and interpretation handler, storing generated output into database in a designed format. The system culminates in the application of time series forecasting, showcasing an integrated approach from data ingestion to practical forecasting applications in an industrial setting.

The Lambda Pipe is designed to enrich the original datasets with additional time-related information. This enhancement is particularly aimed at introducing a time/seasonality component to the model. At its core, the pipe first establishes a baseline date to anchor all time-based calculations. Further refining the dataset, the function extracts and categorizes different time components, day, hour, and minute, as a feature engineering process. Such effort not only simplifies and groups data but also enhances the performance of machine learning models by introducing seasonal characteristic of one or more signals and/or non-sensor data (e.g., power data, production schedule data). For example, the signals (e.g., such as production data or operator shift data mentioned above) are relevant predictors (e.g., have high statistical importance) for forecasted industrial energy demand.

In some embodiments, the purpose of Lambda pipe is to enable non-sensor data (e.g., production data) to be unified into feature set alongside sensor data. This categorical and/or tabular data is typically ingested from ERP or MES systems that do not match the format of sensor data typically sourced from historian systems, so the purpose of this pipe is to explicitly relate this production data to temporal dimension in order to enrich feature set, and in turn, generate significantly more informed, and therefore accurate, predictions (e.g., of industrial energy demand).

This Lambda Pipe is designed to transform feature data from a tabular format into a time series format, focusing on the analysis of features over time. This transformation involves several key steps, each aimed at extracting meaningful temporal alignment from the raw data.

The initial phase involves segmenting features into predefined groups based on their physical characteristic. This categorization is achieved through a custom function that maps each physical characteristic, such as length, thickness, and width, to a specific group based on its recorded MES value falling within certain intervals. This step enriches the dataset by adding a new feature that reflects the categorized characteristics of each production data or manufacturing execution system (MES) data (e.g., data relating to work in progress or intermediate production operations).

Following the categorization, the pipe focuses on the temporal aspects of the data. It first performs operations to identify changes in feature categories over time. By comparing the current feature category with the previous one, the function flags moments of change. This process results in the creation of segments, each representing a period during which the feature category remains constant.

To further refine the data's temporal structure, these segments are then processed to capture their start times, effectively transforming the tabular data into a series of time-stamped events. This transformation is crucial for analyzing how the feature categories evolve over time.

Followed by the temporal structuring, the time-stamped data undergoes resampling to a finer granularity, ensuring that each time period is consistently represented and facilitating analysis at regular intervals. The resampling process also includes a step to handle missing values by forward-filling them, ensuring the continuity of the time series.

Finally, the data is aggregated over specified intervals (e.g., every 15 minutes), applying a mode operation to summarize the most common category within each interval. This aggregation step condenses the time series data, making it more manageable and suitable for analysis, by highlighting the predominant category over time intervals.

The output of the function is a pandas DataFrame that represents the transformed time series data. This pandas DataFrame includes time-stamped entries that reflect the most common category for each aggregated time interval.

This transformation process, from tabular to time series data, enables the original tabular data to be used for the time series analysis model and enhances the temporal analysis in understanding patterns and trends within datasets.

The Temporal Fusion Transformer (TFT) stands out in time series forecasting for its ability to handle both time series data and categorical data. It supports rich feature types, including known and unknown future inputs, along with static categorical variables, making it versatile for diverse datasets. TFT's architecture allows for processing heterogeneous time series data from various distributions, offering multi-horizon forecasting with prediction intervals. Its use of an attention-based mechanism enhances interpretability, a significant advantage when dealing with complex datasets such as the tensors amalgamating signals across production schedules, asset sensors, utility meters and bills, maintenance logs, operator shift data, and SKU or product batch attributes. Moreover, TFT has shown superior performance over traditional models like ARIMA and other deep learning models, highlighting its effectiveness for both time series and categorical data forecasting.

One can view this forecasting module as differentiated from prior art due to its comprehensiveness. Embedding every data processing step mentioned above into an orchestrator—as described, along with additional benefits, below—facilitates rapid end-to-end deployment, integration into business processes, and financial value generation via peak shaving methods described above, which is not achievable using prior art. In addition, the forecast module's orchestrator (e.g., orchestrator module 322) can provide comprehensive data fusion as described above (e.g., via temporalization of categorical data via the Lambda Pipe). Consolidating historical, future time series and temporalized categorical data into a unified feature set consumable by modern algorithms such as TFT offers significantly improved performance over prior art as these three types of data sources are inherently the strongest signals of future energy demand in industrial settings. Categorical production data typically dominates in feature importance, making the temporalization data processing step critical to achieve forecast accuracy that is requisite to drive business value. Furthermore, embedding these data processing orchestrator vertices and machine learning model iteration steps within a broader model driven architecture provides a solution that is maintainable and flexible. For example, an abstract model deployment framework in conjunction with thorough access control implementation offers appropriate end users the ability to promote and demote forecast models without needing to write code via the interface module. Despite common tradeoffs among power, accuracy, and results interpretation of prior art modeling systems, the forecast orchestrator described herein also supports superior explanation of model results than prior art in addition to superior accuracy. The orchestrator module 322 can automate and finish explanation of forecast model results across the several explanation frameworks supported by the TFT architecture. Downstream vertices within the orchestrator calculate and persist attention values (temporal contribution functions conveying periodic signals), encoder variable importances, decoder variable importances, and quantiles providing a confidence range in a format ready for consumption and display by the interface module, so that lay users can rapidly interpret and in turn, accept model results into their business processes to drive financial value for their enterprises. The orchestrator also offers the ability to decompose a forecasting problem into more atomic sub problems or modules to account for complex factors. For example, vertices within the orchestrator can call smaller models which predict the deviation from the planned production schedule based upon historical operator shift data, which can significantly inform and improve the accuracy of the ultimate prediction of energy demand. Nonconformity to planned production is a common problem that typically varies across operations team personnel and introduces a significant source of stochasticity and inaccuracy in prior art systems.

In some implementations, the forecasting module 310 can apply AI-driven forecasting to any of the resources described herein, such as to predict resource outputs (e.g., emissions), resource inputs (e.g., fuel consumption), and the like. The forecasting module 310 may use any of the models described herein to determine forecasts. Forecasting may, for example, help the machine learning-based resource prediction and optimization system 102 determine corrective reports, alert users, or systems, generate reports, and/or the like.

The degradation detection module 312 can function to provide machine learning-based degradation detection for assets and/or facilities. For example, when an asset (e.g., a piece of equipment) degrades in efficiency, it can produce more resource outputs (e.g., emissions) for the same throughput (e.g., amount of resource produced). That change in efficiency can be detected using artificial intelligence models of the degradation detection module 312.

The optimization and recommendation module 314 can function to optimize efficiency, minimize or maximize resource inputs or outputs, and provide other benefits at the organizational level, facility level, and the asset level. The optimization and recommendation module 314 can use predicted resource baselines to facilitate resource optimization. For example, a predicted baseline may indicate that an asset should produce X amount of resource output (e.g., greenhouse gas emissions). The amount of resource output actually generated by the asset can be compared with the predicted baseline to determine how well it is operating. For example, if the asset is generating more output than the predicted baseline, the system may indicate (e.g., by generating an alert) that the asset is operating inefficiently. Conversely, if the asset is generating a lower amount of resource output than the predicted baseline, the system may indicate that the asset is operating efficiently. Furthermore, the baseline can be used to quantify potential reductions of resources (and/or increase in efficiency), such as emissions, based on average-case, best-case, and/or worst-case scenarios.

The optimization and recommendation module 314 can facilitate compliance with standards protocols. For example, the optimization and recommendation module 314 may use AI-generated baselines to more accurately quantify how facilities are on track to meeting commitments to reducing resource outputs (e.g., greenhouse gas emissions) to satisfy various standards protocols. In another example, the optimization and recommendation module 314 may use scenario-based (or, simulation-based) predictions to recommend corrective actions to satisfy various standards protocols.

In some implementations, the optimization and recommendation module 314 may implement generative artificial intelligence methodologies and models. More specifically, the optimization and recommendation module 314 can effectively recommend and/or trigger corrective actions (e.g., for reducing resource outputs). For example, the optimization and recommendation module 314 can generate recommendations in response to natural language inputs (e.g., “How can I reduce my organization's greenhouse gas emissions?”), and the optimization and recommendation module 314 may respond with an intuitive human-readable set of instructions for reducing greenhouse gas emissions (e.g., replacing particular equipment and/or other assets). Corrective actions can include adjusting schedules, adjusting model inputs, adjusting asset or facility configurations, and the like.

The optimization and recommendation module 314 can also provide artificial intelligence-driven process optimization. This may be applicable, for example, when the resource of interest (or “target” resource) can be controlled by adjusting setpoints. The artificial intelligence models can be used to simulate what the outputs could be (or could have been) for a different set of setpoints. If the underlying process would operate better with those different setpoints, then they can be recommended to the end-user or system as actionable insights. For example, a reduction of a certain asset (e.g., equipment) setting by a specified amount would achieve a reduction of resource output (e.g., greenhouse gas emissions) by 20% without affecting quality or yield.

Counterfactuals can leverage the artificial intelligence models to automatically identify setpoints that would achieve a desired model prediction. For example, to achieve a reduction of resource outputs (e.g., greenhouse gas emissions) by 30%, the optimization and recommendation module 314 may change a certain asset (e.g., equipment) setting by a specified amount. Constraints on setpoints can also be defined so that recommendations are feasible. In some implementations, only certain setpoints can be modified at a certain time, and setpoints can take only values in a specified range.

In some implementations, the optimization and recommendation module 314 implements generative artificial intelligence methodologies and models. More specifically, the optimization and recommendation module 314 can effectively recommend corrective actions (e.g., for reducing resource outputs). For example, the system can generate recommendations in response to natural language inputs (e.g., “How can I reduce my organization's greenhouse gas emissions?”), and the system may respond with an intuitive human-readable set of instructions for reducing greenhouse gas emissions (e.g., replacing particular equipment and/or other assets). Although in this example the input is a user input, it will be appreciated that inputs can also include system inputs (e.g., machine-readable inputs).

The optimization and recommendation module 314 may provide the input to one or more omni-modal models, large language models, and/or other machine learning models, which can interpret the query and determine an answer using context provided by the models and the underlying features of the optimization and recommendation module 314. For example, the models may have been specifically trained on, fine-tuned on, or provided with (e.g., as contextual prompts) some or all of the data described herein (e.g., the industry-specific data described above), which can allow the optimization and recommendation module 314 to make inferences in response to the natural language input that other machine learning systems would not be able to do. The optimization and recommendation module 314 may leverage the specifically tuned large language models to not only generate predicted baselines and forecasts, but also recommended corrective actions. In one example, the optimization and recommendation module 314 can generate enterprise-scale, detailed net zero plans composed of concrete, actionable recommendations. The optimization and recommendation module 314 may also generate new material discovery for alternative, sustainable product formulations and carbon capture and storage technologies. The predictions can be generated in real time as a time-series. The predictions can be used to generate a time series of recommendations that include optimized control actions or adjustments for a multitude of assets across a multiple facilities. Large scale organizations can leverage information about manufacturing equipment from different vendors with real-time operational data from the equipment, facility, environment, and organization to predict opportunities for corrective action that yields reduction waste and byproduct such as greenhouse gas emissions.

In some implementations, inputs (e.g., natural language inputs) can trigger functionality of the optimization and recommendation module 314 and/or other modules of the machine learning-based resource prediction and optimization system 102 (e.g., generating predictions, insights, etc.), although it may also use or retrieve previously generated predictions, insights, etc. In that regard, the optimization and recommendation module 314 may generatively select particular insights, predictions, and the like.

In some implementations, the optimization and recommendation module 314 can use generative artificial intelligence to cooperate with interface module 332 to provide a user interface (e.g., graphical user interface) through which answers containing text, charts, and other visualizations can be provided to text-based questions relevant to the application. The optimization and recommendation module 314 may also trigger the machine learning model training module 320 to fine-tune large, code-producing models with transfer learning techniques, retraining them on a type system (e.g., a model-driven architecture-based type system) and user interface design language documentation and existing code so that they can automatically code up user interface components populated with specific relevant data of interest in a visual format conducive to answering the user's query. In some implementations, the user interface can take the form of a personalized daily assistant which prioritizes recommendations and alerts for each user on a day-to-day basis.

In some implementations, the optimization and recommendation module 314 can store context so that follow-up questions can be asked by the user in a natural language format. For example, a first input may be “What were the emissions for facility X in the past year?” and the system may return an answer using generative artificial intelligence, such as “The total emissions for facility X over the past year was Y CO2e.” The user may follow up with a second input “Which pieces of equipment were the worst?” and the system may return an answer using generative artificial intelligence, such as “The top five equipment in facility X that had the most emissions in the past year were (1) Equipment 5:2 CO2e, (2) Equipment 1:1.5 CO2e, (3) Equipment 2:1.3 CO2e, (4) Equipment 4:1.2 CO2e, (5) Equipment 3:0.8 CO2e.” The user may follow up with a third input “Where are the best savings opportunities?” and the system may return an answer using generative artificial intelligence “Based on baselines that were generated using artificial intelligence using the contextual information, the top five pieces of equipment in facility X by greenhouse gas reduction potential are: (1) Equipment 5:1.4 CO2e, (2) Equipment 1:1.1 CO2e, (3) Equipment 2:0.8 CO2e, (4) Equipment 4:0.6 CO2e, (5) Equipment 3:0.4 CO2e.”

In some implementations, the optimization and recommendation module 314 can tailor content and style of responses according to the position within the organization of the user providing the input/query (e.g., role-based). The optimization and recommendation module 314 may also generate periodic (e.g., weekly) reports containing text, charts, and other visualizations which summarize the resource outputs and reduction opportunities across all assets and facilities. The optimization and recommendation module 314 may also cooperate with artificial intelligence traceability module 316 and the interface module 332 to generate visualizations for global and local weights in a metadata framework to provide explainability/traceability.

In one example, the optimization and recommendation module 314 can generate different internal reports for a plant manager as opposed to an executive. The reports may also adhere to the GHG Protocol Corporate Accounting and Reporting Standard and ISO-50001. The content and style of each report can be tailored according to the target audience.

The optimization and recommendation module 314 may generate alerts, reports, dashboards, and recommendations for corrective actions that can be taken to mitigate resource outputs for specific assets and/or specific facilities. The content and style of any of these can be tailored by the machine learning-based resource prediction and optimization systems (e.g., according to the target audience).

The optimization and recommendation module 314 may also use generative artificial intelligence to improve onboarding processes. For example, when onboarding customers they may provide information regarding their assets and facilities. For example, they may provide equipment serial numbers. The optimization and recommendation module 314 can use generative artificial intelligence to look up that identifier and determine the equipment and what is the associated body of knowledge that it can use as context for making recommendations associated with that equipment. In some implementations, the optimization and recommendation module 314 may perform similar processes even when the assets are not explicitly known during the onboarding process. In such an example, the optimization and recommendation module 314 may be able to use an image (e.g., captured by someone from inside the facility) to identify the assets and look up an identifier for that asset and figure out the equipment serial number the associated body of knowledge that it can use as context for making recommendations associated with that asset.

The optimization and recommendation module 314 may also facilitate standards protocol compliance. For example, the optimization and recommendation module 314 may use scenario-based (or, simulation-based) predictions to recommend corrective actions to satisfy various standards protocols. In some implementations, the optimization and recommendation module 314 and processes described herein comply with the GHG Protocol Corporate Accounting and Reporting Standard,” and/or the forthcoming standard titled “GHG Protocol Project Quantification Standard.” The optimization and recommendation module 314 and processes May also be compliant with the “International Performance Measurement and Verification Protocol (IPMVP)” in that resource output reductions can be tracked against baselines and changes made to equipment (e.g., upgrades, optimizations, etc.). The optimization and recommendation module 314 and processes may also be compliant with ISO-50001 and can help enable organizations to become certified to ISO-50001.

In some implementations, the optimization and recommendation module 314 provides (e.g., triggers) baseline predictions/selection (e.g., selection of a baseline scenario and resource) according to a standards protocol. For example, the baseline scenario can represent what would have happened in the absence of the project. Baseline resource output (e.g., emissions) is the hypothetical resource output associated with the scenario. The selection of the baseline scenario may always involve uncertainty because it represents a hypothetical scenario for what would have happened without the project. The project reduction can be calculated as the difference between the baseline and the project resource output. This may differ from the way some corporate or organizational reductions are measured (e.g., in relation to an actual historical base year).

In some implementations, the optimization and recommendation module 314 provides anomaly detection. More specifically, the optimization and recommendation module 314 can predict and use baselines to detect when resource output values are anomalous. This may be a short-term deviation from expected baselines (e.g., as opposed to degradation, which is a long-term deviation).

It will be appreciated that some or all of the features of the machine learning-based resource prediction and optimization system 102 can be implemented using a model-driven architecture. In some implementations, the machine learning-based resource prediction and optimization system 102 comprises a portion of an artificial intelligence platform implementing a model-driven architecture.

As used herein, resource outputs may be direct resource outputs from an organization's owned or controlled assets and/or facilities, indirect resource outputs from purchased energy, and/or indirect value chain resource outputs. For example, a resource output may be greenhouse gas emissions. Greenhouse gas emissions may be calculated based on the gas composition of the fuel that is being burned to generate energy. Gas composition may comprise a breakdown of multiple gases in a fuel mixture that is burned as part of an industrial process. The breakdown by component gas can be expressed as a percentage. Gases may also include “feedstock” that is not burned (e.g., natural gas). Throughput may be an amount of product (e.g., resource output) produced. Efficiency may be throughput/resource output (e.g., emissions).

In some embodiments, the optimization and recommendation module 314 may select the model that is most suitable to manufacturing operation datasets and their properties, e.g., nonlinear relations between features and target, change in operating regimes, which require extrapolation. In some implementations, the generative artificial intelligence component of the optimization and recommendation module 314 includes an interface comprising one or more abstraction layers that connect the functionality of the machine learning-based resource prediction and optimization system to various end-user front ends. For example, a front-end may include a graphical user interface that accepts natural language inputs (e.g., search queries input into a search box) which the interface can interpret (e.g., using one or more omni-modal or large language models) to generate a result (e.g., an answer) using machine learning and/or other functionality of the machine learning-based resource prediction and optimization system. In some implementations, some or all of the functionality optimization and recommendation module 314 may be included in other modules (e.g., modules 334-338) and the optimization and recommendation module 314 may communicate with those module(s) to perform that functionality.

The artificial intelligence traceability module 316 can function to provide traceability and/or explainability of outputs generated by the models described herein. For example, the artificial intelligence traceability module 316 can indicate portions of data used to generate outputs and their respective data sources. The artificial intelligence traceability module 316 can also function to corroborate model outputs. For example, the artificial intelligence traceability module 316 can provide sources citations automatically and/or on-demand to corroborate or validate large language model outputs. The artificial intelligence traceability module 316 may also determine the compatibility of the different sources (e.g., data records, passages) that were used to generate a model output. For example, the artificial intelligence traceability module 316 may identify data that contradicts each other and provide a notification that the output was generated based on contradictory on conflicting information.

The artificial intelligence traceability module 316 may generate and/or otherwise provide evidence packages. For example, the artificial intelligence models described herein may place different emphases on different features. Those emphases can be quantified and/or visualized so a user (e.g., operator) can understand and validate that the artificial intelligence models are indeed paying attention to the right features and not suffering spurious corrections (e.g., global feature contributions). The artificial intelligence models described herein can also make predictions/inferences that can be associated with the extent to which each feature contributed to the predictions taking a certain value (local feature contributions).

The artificial intelligence traceability module 316 can generate and provide evidence packages of predictions and other features of the systems. For example, the drivers of artificial intelligence models of the systems can be visualized at the level of individual machine learning models and the level of individual predictions made by those models. Machine learning-based resource prediction and optimization systems can also detect regime shifts. For example, when data changes with time, it can affect the performance of some or all of the models described herein, and a data drift (or, regime shift) detection scheme of the machine learning-based resource prediction and optimization system may address the data drift (e.g., by identifying and retraining particular models). Machine learning-based resource prediction and optimization systems may also can use regime shifts to detect (1) degradation of equipment efficiency (2) different states of equipment operation (e.g., start-up/shut-down/steady state, etc.), (3) different modes of operation (e.g., motor speed 1, 2, etc.), and/or (4) machine learning model performance degradation (e.g., for forecasting models if the error, between what ML predicts and what the sensors eventually measure, increases over time), indicating a need to retune and/or rearchitect the ML model.

The model management module 318 can function to capture feedback regarding model performance (e.g., response time), model accuracy, system utilization (e.g., model processing system utilization, model processing unit utilization), and other attributes. For example, the feedback module 440 can track user interactions within systems, capturing explicit feedback (e.g., through a training user interface), implicit feedback, and the like. The feedback can be used to refine models (e.g., by the machine learning model training module 320).

The model management module 318 can be used to enable tuning and learning by the optimization and recommendation module 314 and the machine learning model training module 320. For example, the model management module 318 may tune the optimization and recommendation module 314 based on tracking user interactions within the system, capture explicit feedback (e.g., through a training user interface), implicit feedback, etc. In some example implementations, the machine learning model training module 320 can optionally be used to accelerate knowledge base bootstrapping. Reinforcement learning can be used for explicit bootstrapping of the system with instrumentation of time spent, results clicked on, etc. Example aspects include an innovative learning framework that can bootstrap models for different enterprise environments. Example aspects include an innovative learning framework that can bootstrap models for different enterprise environments.

The machine learning model training module 320 can function to train, retrain, and/or refine the models described herein. For example, models can be trained and/or fine-tuned via transfer learning techniques on domain-specific documents and literature on manufacturing, industrial systems, energy management, and sustainability (e.g., equipment manuals, journals, research papers, etc.,) to provide specific, actionable steps to efficiently reduce resource inputs (e.g., energy consumption) and/or resource outputs (e.g., emissions). This may be based on an understanding of what modifications can be made to equipment settings to make them operate with reduced emissions. This may be based on the knowledge of the age and operating characteristics of each piece of equipment, the typical replacement/upgrade/maintenance cycle of that type of equipment, and the most applicable and effective decarbonization technologies to adopt for each process and asset type. For example, install variable speed/frequency drives or heat recovery systems on specific equipment types.

The machine learning model training module 320 may also detect regime shifts (e.g., data drift). Regime shift detection broadly applies to changing data through time. When data changes over time, it may be detectable by making comparisons of windows of that data taken in a certain period with a different window of the same data taken at a different period. A regime shift can be detected by computing the divergence between the two windows. Types of divergence include Jensen-Shannon divergence and Kullback-Leibler. Jensen-Shannon divergence may be preferred because it is symmetric, and the value is from 0-1, making it easy to mark a threshold denoting a regime shift at a predefined value (e.g., 0.7). Kullback-Leibler may not be as preferable because it is asymmetric, and the value is positive, but not bounded, making it difficult to mark a threshold to flag a regime shift.

In some implementations, the machine learning model training module 320 can use regime shift detections to indicate when a model needs to be retrained. For example, if an asset (e.g., a piece of equipment) has undergone some sort of change or degradation, the sensor data that comes from that asset might undergo a regime shift. Subsequently, the model corresponding to that asset can be retrained for improved accuracy, as it would use only the latest and most relevant regime of input data to model resources in the present.

In some embodiments, the machine learning model training module 320 trains and/or refines models using diverse datasets, such as future-known continuous data, future-known categorical data, static categorical data, future-unknown continuous data, future-unknown categorical data (e.g., that correlate with electricity usage). Each of these may be model features and/or model inputs (e.g., for training or production).

In some implementations, the machine learning model training module 320 can configure and train multiple models (e.g., machine learning models) for baseline prediction. The models may be trained on historical, current, and/or simulated data. In one example, a machine learning-based resource prediction and optimization system can train each of the models to predict different quantiles, such as a 5^{th} percentile, 50^{th} percentile (e.g., mean), and 95^{th} percentile. In such an example, the 5^{th} percentile model may correlate to some of the best (e.g., lowest) resource outputs seen for a particular piece of equipment given current conditions, the 50^{th} percentile model may correlate to average resource outputs seen for the particular piece of equipment, and the 95^{th} percentile model may correlate to some of the worst (e.g., highest) resource outputs seen for the particular piece of equipment. Lowest may correlate to the best case in the context of various resources (e.g., emissions) or worst case in the context of efficiency. Highest may correlate to worst case in the context of various resources (e.g., emissions) or best case in the context of efficiency.

Generally, the baseline can be used to give an asset (e.g., equipment) a grade or other evaluation indicating whether it is operating close to its best-case performance, average-case performance, and worst-case performance. The grade can be updated every day or as configured. In some implementations, the machine learning-based resource prediction and optimization systems may classify results near a particular percentile (e.g., the 5^{th} percentile) with a green label (e.g., indicating highly efficient), results near another percentile (e.g., the 50^{th} percentile) with a yellow label, and results near another percentile (e.g., the 95^{th} percentile) with a red label (e.g., indicating highly inefficient) and may notify one or more users or systems accordingly. It will be appreciated that three quantiles are used in this example but there may be a greater or lesser number of such quantiles. Furthermore, the given example percentiles (e.g., 5^{th}, 50^{th}, 95^{th}) are just that—examples, and different percentiles may be used instead of, or in addition to the examples provided here.

In some implementations, the machine learning model training module 320 may use a single model technique instead of, or in addition to, the multiple model technique. More specifically, the machine learning model training module 320 can train a single model to learn the probability distribution of the resource being baselined, conditioned on the features. The parameters of that probability distribution can then be used by the machine learning-based resource prediction and optimization system to compute percentile values. This single model technique has some advantages over having multiple models. For example, a single model may reduce the overhead of model management, and/or ensure consistency between predictions for different quantiles (e.g., the 95^{th} percentile will always be greater than the 90^{th} percentile). Regardless of the technique (e.g., multiple or single model), the models may comprise Generalized Additive Models (GAMs), Generalized Linear Models (GLMs), TFTs, and/or other machine learning or statistical models.

In some implementations, the machine learning model training module 320 can train and/or refine models on domain-specific datasets and/or use models that have been trained on domain-specific datasets. For example, omni-modal models, large language models, etc., can be trained and/or fine-tuned on (or take as contextual inputs) industry-specific documents, literature, user manuals, equipment manuals, asset manuals, sensor manuals, facility manuals, and/or the like. This can be particularly useful for providing the generative artificial intelligence features discussed elsewhere herein.

The orchestrator module 322 can function to automate some or all of the functions described herein. For example, the orchestrator module 322 can generate and automate workflows for determining asset or facility efficiency and resource utilization, determining corrective actions to address inefficiencies, and the like. The orchestrator module 322 can automate user-defined workflows and/or generate new workflows (e.g., based on success of previous workflows) compromised of key steps in the data assembly process such as cleaning, generation, ingestion, and normalization of the data. The orchestrator module 322 can also be used to automate the dataset preparation phase of the deployment pipeline by offering a highly customizable solution where users can specify complex masking logics on the asset-level. The orchestrator module 322 will take the users specifications and automatically create the necessary masking metrics and feature sets required for multi-asset machine learning training and inference. The orchestrator module 322 is also capable of automatically training, deploying, and persisting the results of multiple machine learning models for multiple assets at once and includes a step in the workflow where it will autonomously select the best model per asset based on a scoring metric. In this manner, users can leverage the orchestrator module 322 to select the best kind of machine learning model architecture and the best set of hyperparameters for a given resource baseline or forecasting use case. For the baselining use case, the orchestrator module 322 offers an additional step to automatically evaluate the asset models for a given cohort and persist the results from the cohort baselining use case.

Additionally, comprehensive encapsulation of tensor flow and processing within a common parent graph offers superior computational performance which is optimized by maximally distributing parallelizable processing instructions, such as hyperparameter optimization, ensemble inference across each cohort's constituent models, inference across the configured asset hierarchy, inference across the set of target variables for each asset, and derived measurement calculation across assets and metrics for a single asset (e.g. emissions calculations performed simultaneously and periodically upon sensor data ingestion across configured assets and corresponding kyoto protocol gasses). The end-to-end workflow implemented in the orchestrator module consists of a directed acyclic graph data structure. Each vertex in the graph represents a data processing step required to generate insights within the application. Wrapping every processing step within a comprehensive and centralized network—from ingestion of raw data sources to preparation of model outputs in the interface module—enables rapid configuration, continuous integration testing, and deployment of the application both horizontally—across new assets and customers—and vertically—across new asset types and target variables within plants already modeled within an application object model. Furthermore, one can distinguish this solution relative to other forms of prior art by its comprehensive automation, abstraction, flexibility to accommodate a wide variety of asset types and manufacturing processes via a model driven architecture. Furthermore, analogous orchestrator architecture automates deployment across asset management functions—as purpose-built end-to-end pipelines spanning the forecasting module 310, the resource baseline prediction module 306, the cohort baseline prediction module 308, the optimization and recommendation module 314, and/or other modules —that can automate deployment, parallelize computational workloads, and leverage common, overlapping data processing steps common across models and asset management objectives.

In some implementations, functionality of the orchestrator module 322 may be included in some or all of the other modules instead of, or in addition to, the orchestrator module 322. For example, functionality of the orchestrator module 322 may “overlap” with one or more of the other modules.

The masking module 324 can function to mask (e.g., apply exclusion masks) portions of data (e.g., asset data, facility data). For example, the masking module 324 may mask periods of “abnormal operations” (e.g., decoking, shutdowns). Accordingly, the masking module 324 can generate accurate results that are not biased by abnormal operations or other potentially biasing data.

The hierarchical aggregation module 326 can function to perform hierarchical aggregation of AI-based forecasts and baselines. This can be particularly useful when calculating/predicting resource outputs/inputs at a facility level. More specifically, accurate results cannot be determined by merely summing the resource outputs/inputs unless the facility only has one type of asset and there are no dependencies between assets. For example, if there are different assets with dependencies with each other, summing the resource inputs/outputs would produce inaccurate results because some inputs/outputs may be “double-counted.” Accordingly, the hierarchical aggregation module 326 may use the hierarchical aggregation discussed herein (e.g., as shown in FIG. 2) to produce accurate results at the facility level when there are different types of assets and/or dependencies.

The hierarchical aggregation module 326 provides several methods for aggregation of quantiles to the facility level. To aggregate the baseline to the facility level, the equipment level predictions (both mean and variance) may be aggregated using sum of random variable rules. The mean may be the facility mean prediction equal to the sum of equipment level prediction. The variance may be facility level variance equal to the sum of the covariance matrix. Aggregating means can be fairly straightforward, however aggregating variances can be more complicated. In some implementations, the hierarchical aggregation module 326 assumes the correlation to be an operating condition (e.g., correlation can be calculated by the gam either as a constant or as a running calculation, but it is not a prediction).

In one example, aggregation may include some or all of the following steps:

Step 1: calculate correlation. Calculating this as a constant for the training can be used. This step provides a matrix size N equipment×N equipment.

Step 2: calculate product of standard deviations. At each time step, the hierarchical aggregation module 326 can use the individual equipment model variance predictions to produce a matrix (size N equipment×N equipment), where each cell contains the product of the standard deviation of equipment in column and equipment in row.

Step 3: compute covariance matrix. To produce the covariance matrix, the hierarchical aggregation module 326 computes the Hadamard product between the correlation matrix and the product of standard deviation matrices at each time step. This computes the product of the cells in the same indices to produce a new matrix at each time step. This is the covariance matrix (size N equipment×N equipment).

Step 4: compute facility level variance. The hierarchical aggregation module 326 then computes the sum of all the cells in our covariance matrix, which generates the facility level variance.

Once the hierarchical aggregation module 326 has the mean and the variance for the facility, the hierarchical aggregation module 326 can use the same approach to produce quantiles that were used for the equipment level predictions.

In some embodiments, the model deployment module 328 can function to obtain, generate, and/or modify some or all of the different types of models described herein (e.g., machine learning models, large language models, data models). In some implementations, the model deployment module 328 can use a variety of machine learning techniques or algorithms to generate models. As used herein, artificial intelligence and/or machine learning can include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, model deployment module 328 can generate and/or use model templates to rapidly and efficiently deploy any of the models discussed herein. For example, model templates can allow an application to be quickly configured by non-expert users using out-of-the-box templates that define everything needed for a machine-learning model to run. Each template can be applied to a plurality of assets allowing easy (e.g., efficient in terms of time and/or computational resources) scaling of model deployments to hundreds (or more) of assets across dozens (or more) facilities.

In some embodiments, a large language model is a deep learning model (e.g., generated by a deep learning algorithm) that can recognize, summarize, translate, predict, and/or generate text and other content based on knowledge gained from massive datasets. Large language models may comprise transformer-based models. Large language models can include Google's BERT, OpenAI's GPT-3, and Microsoft's Transformer. Large language models can process vast amounts of data, leading to improved accuracy in prediction and classification tasks. The large language models can use this information to learn patterns and relationships, which can help them make improved predictions and groupings relative to other machine learning models. Large language models can include artificial neural network transformers that are pre-trained using supervised and/or semi-supervised learning techniques. In some embodiments, large language models comprise deep learning models specialized in text generation. Large language models, in some embodiments, may be characterized by a significant number of parameters (e.g., in the tens or hundreds of billions of parameters) and the large corpuses of text used to train them.

The model deployment module 328 can generate, deploy, and/or use model templates to generate or deploy models, which can accelerate deployment of models across subjects and use cases. In various implementations, as used herein, models may include machine learning models, statistical models, large language models, and or other models. More specifically, the model deployment module 328 can generate and store many different model templates that each describe respective features, targets, modeling approaches, training set definitions, training cadences, and/or inference cadences for a model. For example, training set definitions can include the start date of any timeseries data used for training and end date of any timeseries data used for training. Training and inference cadence define how frequently the machine learning model is used to be retrained and generate predictions, respectively. Examples are hourly, daily, weekly, monthly, quarterly, annually, etc. Additionally, training and inference can be triggered by a user (e.g., through an interface) or by some sort of event (e.g., retrain if the model accuracy drops below a specified threshold).

In some implementations, the model deployment module 328 can further configure model templates to specify what subjects they apply to (e.g., business units, facilities, equipment, sensors, etc.). The model input module 330 can function to obtain, generate, and provide model inputs (e.g., to any of the models described herein.). The model input module 330 may also use different model configurations and/or feature configuration for model inputs. More specifically, features can be pre-specified transformations of data that are relevant to modeling resources using data described herein. Those transformations can be stored and made available to any systems or users interested in applying those transformations for a specific facility/asset/sensor or, more broadly, for types of facilities/asset/sensors.

In some embodiments, features can be defined by end users through systems (e.g., through a graphical user interface generated by interface module 332). More specifically, the approach can be simplified by identifying the underlying data used in the feature transformations through identifiers or descriptions of that data. For example, if sensor data is being used to model an asset, the sensors can be identified by their descriptions and used accordingly.

Feature assignment to models can also be manual and/or automatic. For example, the features can be assigned to models by an end user or system (manual), and/or the features can be assigned to models using templates (automatic), described elsewhere herein. Furthermore, once features are assigned to a model, they can be used in training (e.g., by the machine learning-based resource prediction and optimization system) based on the availability of underlying data (e.g., feature(s) can be excluded if the underlying data is insufficient or absent), and/or an importance (e.g., relative value) to the models through different techniques (e.g., forward feature selection, leave-one-out, etc.), and features can be included based on an extent to which they contribute to model accuracy.

The interface module 332 can function to receive inputs (e.g., complex inputs) from users and/or systems. The interface module 332 can also generate and/or transmit outputs. Inputs can include system inputs and user inputs. For example, inputs can include instructions sets, queries, natural language inputs or other human-readable inputs, machine-readable inputs, and/or the like. Similarly, outputs can also include system outputs and human-readable outputs. In some embodiments, an input (e.g., request, query) can be input in various natural forms for easy human interaction (e.g., basic text box interface, image processing, voice activation, and/or the like) and processed to rapidly find relevant and responsive information.

The interface module 332 can function to generate graphical user interface components (e.g., server-side graphical user interface components) that can be rendered as complete graphical user interfaces on the machine learning-based resource prediction and optimization system 102 and/or other systems. For example, the interface module 332 can function to present an interactive graphical user interface for displaying and receiving information.

The communication module 340 can function to send requests, transmit and receive communications, and/or otherwise provide communication with one or more of the systems, services, modules, registries, repositories, engines, layers, devices, datastores, and/or other components described herein. In a specific implementation, the communication module 340 may function to encrypt and decrypt communications. The communication module 340 may function to send requests to and receive data from one or more systems through a network or a portion of a network (e.g., communication network 112). In a specific implementation, the communication module 340 may send requests and receive data through a connection, all or a portion of which can be a wireless connection. The communication module 438 may request and receive messages, and/or other communications from associated systems, modules, layers, and/or the like. Communications may be stored in the machine learning-based resource prediction and optimization system datastore 350.

FIG. 4 depicts a diagram 400 of an example system architecture and flow (e.g., of a machine learning-based resource prediction and optimization system 102 and/or forecasting module 310) integrating Temporal Fusion Transformers (TFT) into the machine learning processes of the machine learning-based resource prediction and optimization system 102 according to some embodiments.

In the example of FIG. 4, the system flow begins with the subject 402. For example, the asset 402 can be any asset, such as a chemical process unit or a steel mill. Given the asset 402, the feature set 404 (e.g., created based on the metrics 403 and features 405) is evaluated to materialize (e.g., surface and/or infer) the corresponding time series operating data and/or sensor data 406 (e.g., time series power data, time series production schedule data). The feature set 404 may include product attributes, product mix, production schedule data, operator shift data, or measured operational parameters. The metrics 403 include operator manning each asset at each timestamp, rotational speed, product tensile strength, etc. The features 405 may include vectorized manipulations or transformations of the aforementioned metrics such as linear or non-linear combinations.

Pre-processing can occur through the Lambda pipe unit 411. The Lambda pipe unit 411 includes time component 408 (e.g., time component Lambda pipe) and the feature component 410 (e.g., feature component Lambda pipe) indicating a preparation of time-based data and feature engineering. In some implementations, the Lambda pipes wrap around native Python functions that implement processing logic and are only used to transform input data and they cannot be trained nor used with a trainable model.

The TFT model 412 (or, TFT pipe) can operate on this prepared data to forecast future resource usage data (e.g., power usage), yielding predictions 414 and corresponding prediction interpretations 416. For example, the predictions 414 can include forecasted energy demand from production equipment or GHG and criteria pollutant emissions, and the prediction interpretations 416 can include encoder and decoder feature importances and attention functions specifying relative temporal contributions. These results can be conveyed to downstream post-processes, which are done by the prediction handler 418 and interpretation handler 420, transforming for consumption and display by the interface module and storing generated output into a database in a designed format. The system flow culminates in the application of time series forecasting 422 and forecasting inference 424, which can showcase an integrated approach from data ingestion to practical forecasting applications in an industrial setting. For example, time series forecasting 422 can include persistence of future (anticipated) energy demand values at various intervals and lookahead periods (e.g. next 6 hours, 24 hours, 48 hours, etc.) and quantile vectors conveying prediction confidence range (e.g. specifying percentiles of interest such as 10^{th} and 95^{th} percentile values for target variable), and the forecasting inference (or, interpretation or explanation persistence) 424 can include persistence of encoder and decoder feature importances and attention function values and mappings.

The time component 408 can be designed to enrich the original resource data with additional time-related information. This enhancement can be particularly aimed at introducing a time/seasonality component to the model 412. The time component 408 can establish a baseline date to anchor all time-based calculations. Further refining the dataset, the function can extract and categorizes different time components (e.g., day, hour, and minute) as a feature engineering process. This not only simplifies and groups data but also enhances the performance of machine learning models by introducing seasonal characteristics of the resource data.

The feature component 410 can be designed to transform feature data 405 from a tabular format into a time series format, focusing on the analysis of features over time. This transformation involves several key steps, which can each be aimed at extracting meaningful temporal alignment from the raw data. The initial phase involves segmenting features into predefined groups based on their physical characteristic. This categorization is achieved through a custom function that maps each physical characteristic (e.g., length, thickness, and width) to a specific group based on its recorded manufacturing execution system (MES) value falling within certain intervals. This step enriches the dataset by adding a new feature that reflects the categorized characteristics of each production data 432.

The production environment 431 can include industrial environments, virtual environments, and/or other types of environments. In the example of FIG. 4, the production environment 431 includes production data 432, production controller 434, and products 436. The production data 432 can include data generated and/or collected during production of the product 436. For example, the production data 432 may include sensor and non-sensor data of a component (e.g., slab) of a metal product 436.

The production controller 434 may control the functioning of one or more assets and/or facilities during production of the products 436. For example, the production controller 434 may be a scheduler. The production controller 434 may receive recommendations and/or instructions to perform recommendations, and implement those recommendations and/or instructions (e.g., to adjust a schedule, adjust configuration of an asset, etc.

Following the categorization, the feature component 410 can focus on the temporal aspects of the data. It first performs operations to identify changes in feature categories over time. By comparing the current feature category with the previous one, the function flags moments of change. This process results in the creation of segments, each representing a period during which the feature category remains constant. To further refine the data's temporal structure, these segments are then processed to capture their start times, effectively transforming the tabular data into a series of time-stamped events. This transformation can be crucial for analyzing how the feature categories evolve over time.

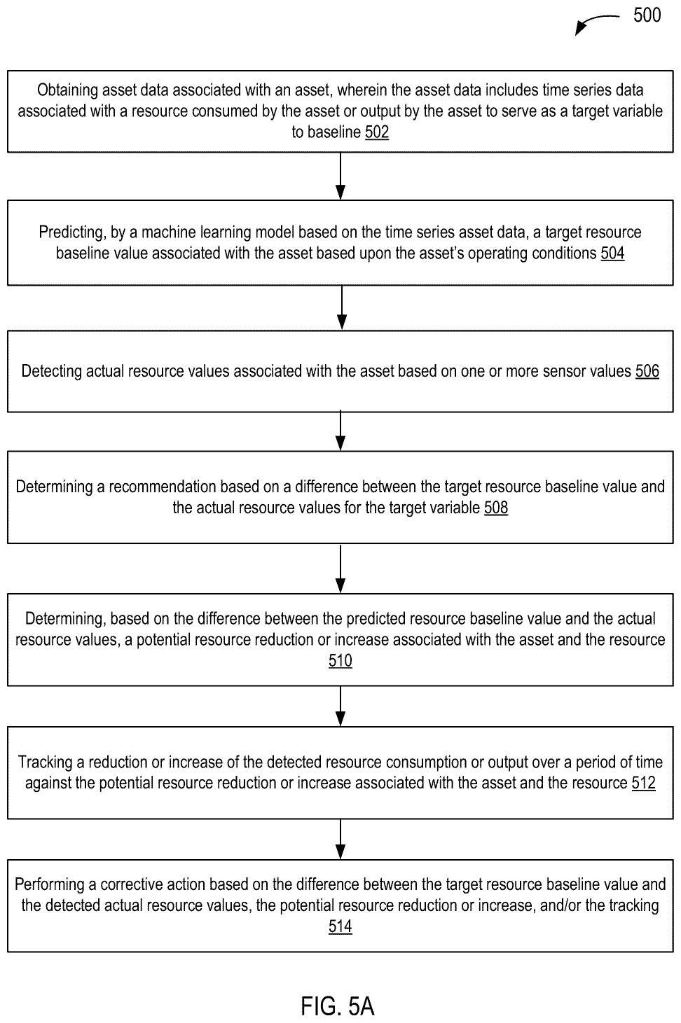

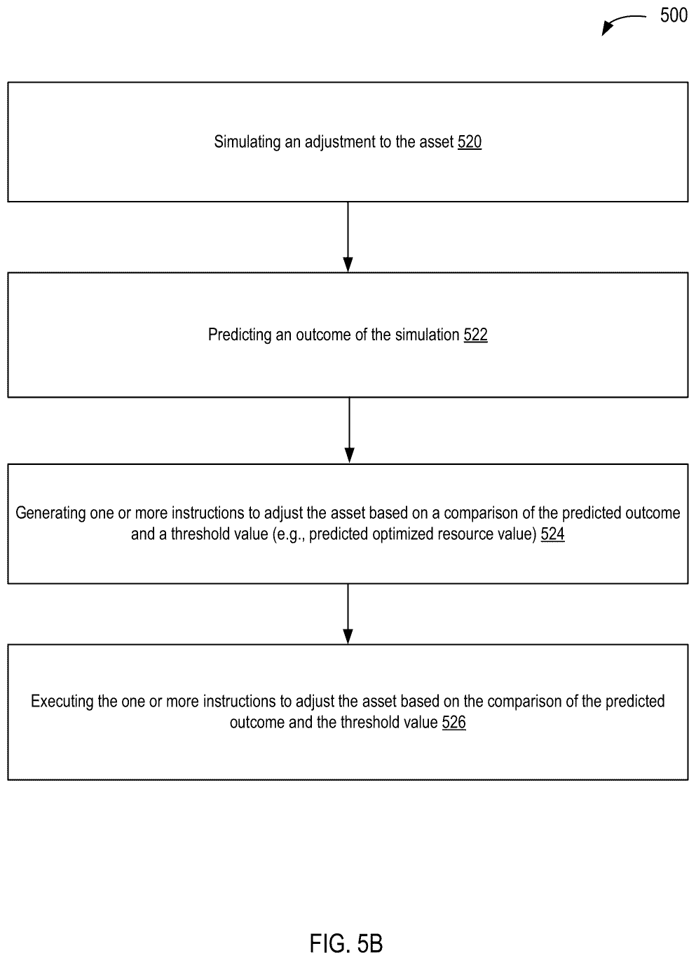

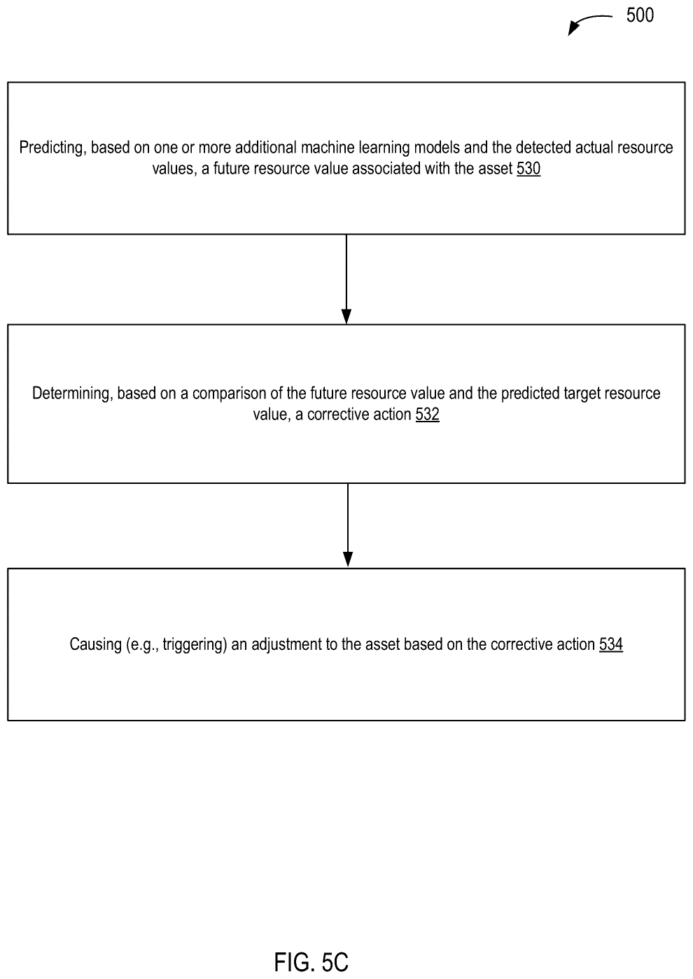

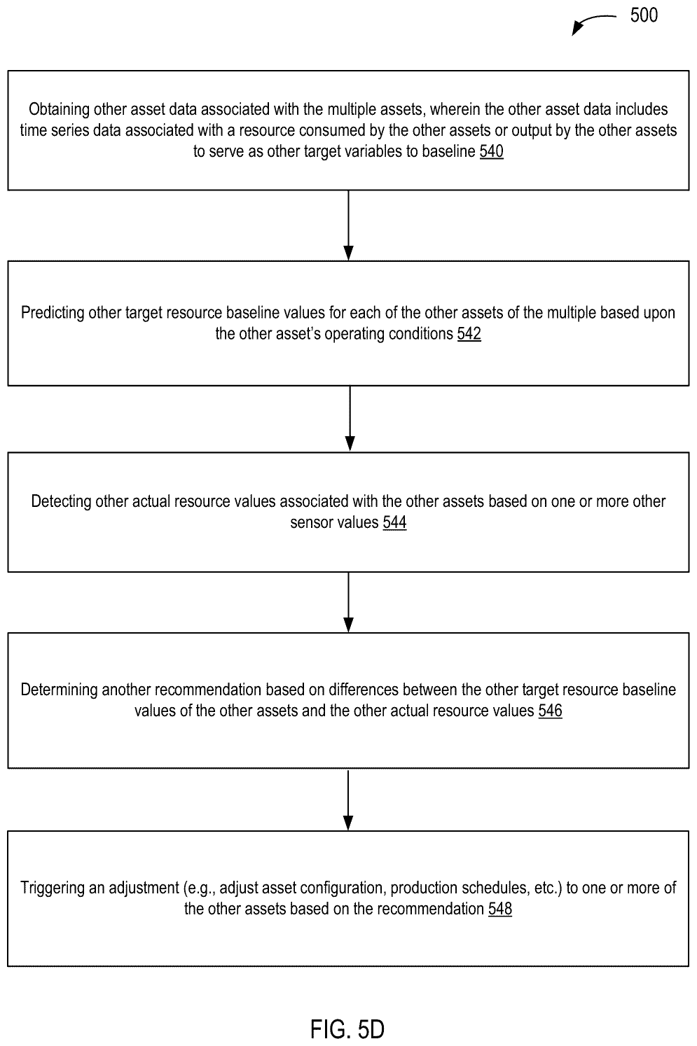

FIG. 5A depicts a flowchart 500 of an example of a method of resource baseline prediction according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 502, a computing system (e.g., machine learning-based resource prediction and optimization system 102) obtains asset data associated with an asset (e.g., asset 104). The asset data may include time series data (e.g., historical time series data, real-time time series data) associated with a resource consumed (e.g., asset input 120, such as fuel) by the asset or output (e.g., asset output 130, such as greenhouse gas emissions) by the asset to serve as a target variable to baseline.

More specifically, the resource consumed and/or output of the asset can include greenhouse gas emissions, electricity consumption or generation, combusted fuels, water, waste, and compressed air, derived resources, virtual resources, etc., and/or other metrics informing operational or sustainability performance. In some embodiments, model management module (e.g., module management module), sensor detection module (e.g., sensor detection module 304), and/or communication module (e.g., communication module 340) obtains the asset data. For example, the communication module can obtain the asset data directly from an asset, a data source (e.g., data source 108), and/or other repositories or services (e.g., weather service).

In step 504, the computing system predicts, by a machine learning model based on the time series asset data, a target resource baseline value associated with the asset based upon the asset's operating conditions. The target resource baseline value (e.g., time series values with corresponding timestamps) may correspond to an expected resource consumption of the asset and/or an optimal (or, “ideal”) resource consumption of the asset (e.g., asset given the asset's vector of operating conditions at each timestamp of the time series data). The target resource baseline value may correspond to an expected resource output of the asset and/or an optimal resource output of the asset. The optimal values (e.g., optimal resource consumption) may be predetermined (e.g., pre-defined) and/or determined dynamically. For example, the optimal value may be adjusted dynamically based on various factors, such as the performance, or predicted performance, of peer assets. In some embodiments, the predicted target resource baseline value includes time series data values predicted over a period of time.

In some embodiments, a resource baseline prediction module (e.g., resource baseline prediction module 306) predicts the target resource baseline value. In step 506, the computing system detects actual resource values associated with the asset based on one or more sensor values. The detected actual resource values can include real-time time series data associated with the resource consumed and/or output by the asset. The target resource values may comprise time series values. In some embodiments, a sensor detection module (e.g., sensor detection module 304) detects the actual resource values (e.g., real-time sensor values).

In step 508, the computing system determines a recommendation based on a difference between the target resource baseline value and the actual resource values for the target variable. In some embodiments, a forecasting module (e.g., forecasting module 310) and/or optimization and recommendation module (e.g., optimization and recommendation module 314) determines the difference. For example, the forecasting module may determine the difference in order to forecast information (e.g., future energy usage), and the optimization and recommendation module may determine the difference to further determine a potential resource reduction or increase (e.g., step 510).

In step 510, the computing system determines, based on the difference between the predicted resource baseline value and the detected actual resource values, a potential resource reduction or increase associated with the asset and the resource. In some embodiments, the optimization and recommendation module determines the potential resource reduction or increase associated with the asset and the resource. In step 512, the computing system tracks a reduction or increase of the detected resource consumption or output over a period of time against the potential resource reduction or increase associated with the asset and the resource. In some embodiments, optimization and recommendation module performs the tracking.

In step 514, the computing system performs (or causes performance, e.g., by a trigger) a corrective action based on the difference between the target resource baseline value and the detected actual resource values, the potential resource reduction or increase, and/or the tracking. In some embodiments, the optimization and recommendation module performs, and/or generates instructions to perform, the correction action. In some embodiments, the computing system can mask data (e.g., a portion of the asset data, a portion of the detected actual resource values), and the computing system can predict the target resource baseline value based on asset data excluding the masked portion of the asset data. In some embodiments, the computing system may use the difference between the target resource baseline value and the detected actual resource values over a period of time to determine and/or perform other actions. For example, the computing system can detect a degradation of the asset based on the difference.

In some embodiments, the computing system detects degradation of the asset based on the difference between the target, optimal, and/or expected resource baseline value(s) (e.g., inferred according to the asset's current operating conditions), and the detected actual resource values over a period of time. In some embodiments, the computing system can provide the recommendation to the asset, thereby causing an adjustment to the asset Although the above steps are described with reference to an asset, some or all of the steps above may be performed for each asset of a set of multiple assets. Some or all of the values described herein may include variable values.

FIG. 5B depicts a flowchart 500 of an example of a method of adjusting an asset based on predicted values and threshold values according to some embodiments. In step 520, the computing system simulates an adjustment to the asset. For example, the computing system may simulate adjusting model inputs, asset performance or efficiency, resource consumption (e.g., fuel consumption), resource outputs (e.g., emissions). In some embodiments, the optimization and recommendation module simulates the adjustment.

In step 522, the computing system predicts an outcome of the simulation. The prediction may include simulating changes to the model inputs, asset performance or efficiency, resource consumption (e.g., fuel consumption), resource outputs (e.g., emissions), and/or other asset parameters or attributes, to predict the outcome. In some embodiments, the resource baseline prediction module and/or optimization and recommendation module can perform the prediction. For example, the resource baseline prediction module may predict an expected resource baseline value for the asset using the adjusted values as model inputs, and the optimization and recommendation module can use the corresponding model outputs to determine a difference between current operation of the asset and the simulated operation. In some embodiments, embodiments, the prediction uses the one or more machine

In step 524, the computing system generates one or more instructions to adjust (e.g., modifications to operational setpoints, parameters, production schedule, maintenance schedule, or capital improvements) the asset based on a comparison of the predicted outcome and a threshold value (e.g., predicted optimized resource value). For example, the computing system may generate instructions to adjust the asset using the changed model inputs and/or a modification the changed inputs. For example, the simulation may iterative (e.g., repeat some or all steps) until the threshold value is satisfied. In some embodiments, the optimization and recommendation module generates the instructions.

In step 526, the computing system executes the one or more instructions to adjust the asset based on the comparison of the predicted outcome and the threshold value. In some embodiments, the optimization and recommendation module executes the instructions, thereby causing an adjustment to the asset (e.g., a physical machine).

FIG. 5C depicts a flowchart 500 of an example of a method of artificial intelligence-driven forecasting according to some embodiments. In step 530, the computing system predicts, based on one or more additional machine learning models and the detected actual resource values, a future resource value associated with the asset. In some embodiments, the forecasting module predicts the future resource value. In step 532, the computing system determines, based on a comparison of the future resource value and the predicted target resource value, a corrective action. In some embodiments, the optimization and recommendation module determines the corrective action. In step 534, the computing system causes (e.g., triggers) an adjustment (and/or other control action) to the asset based on the corrective action. For example, the computing system may generate instructions for the adjustment, and transmit the instructions to the asset and/or associated production controller (e.g., production controller 434) over a network (e.g., communication network 112). In some embodiments, the optimization and recommendation module causes the adjustment to the asset.

FIG. 5D depicts a flowchart 500 of an example of a method of cohort baseline prediction according to some embodiments. In step 540, the computing system obtains other asset data associated with the multiple assets, wherein the other asset data includes time series data associated with a resource consumed by the other assets or output by the other assets to serve as other target variables to baseline. In step 542, the computing system predicts other target resource baseline values for each of the other assets of the multiple based upon the other asset's operating conditions. In step 544, the computing system detects other actual resource values associated with the other assets based on one or more other sensor values. In step 546, the computing system determines another recommendation based on differences between the other target resource baseline values of the other assets and the other actual resource values. In step 548, the computing system causes (e.g., triggers) an adjustment (e.g., adjust asset configuration, production schedules, etc.) to one or more of the other assets based on the recommendation.

In some embodiments, some or all of the steps of flowchart 500 (e.g., depicted in FIGS. 5A-D) can be performed with respect to multiple assets across one or more facilities. Accordingly, the computing system may predict resource baselines for multiple assets in multiple facilities to determine asset efficiency, facility efficiency, organizational efficiency, and the like.

FIG. 6 depicts a flowchart 600 of an example of a method of cohort baseline prediction according to some embodiments. In step 602, a computing system (e.g., machine learning-based resource prediction and optimization system 102) determines a cohort of assets. The cohort of assets may be determined based one or more similar and/or same attributes (e.g., manufacturer, model, model year, asset input(s), output, etc.) of the assets. In some embodiments, the cohort baseline prediction module (e.g., cohort baseline prediction module 308) determines (e.g., defines) the cohort of assets. Similar attributes may be determined based on one or more predefined cohort rules that indicates similar assets and/or threshold values for determining similarity.

In step 604, the computing system obtains asset data associated with a particular asset of the cohort of assets. The asset data may include time series data (e.g., real-time, or “live,” time series data) associated with a resource consumed by the asset or output by the asset and/or relevant operational variables configured by subject matter experts or automatically via statistical methods. In some embodiments, a management module (e.g., management module 302) and/or communication module (e.g., communication module 340) obtains the asset data directly from an asset, a data source (e.g., data source 108), and/or other repositories or services (e.g., weather services).

In step 606, the computing system predicts, for each asset of the cohort of assets, a respective target resource baseline value. Each of the respective target resource baseline values may be predicted by a different machine learning model based on the asset data associated with the particular asset of the cohort of assets. For example, there may be a different machine learning model for each of assets of the cohort. The respective predicted target resource baseline values may correspond to an expected resource consumption and/or expected resource output of the assets of the cohort of assets. In some embodiments, step 606 includes inferring across the most salient multi-dimensional vector space of asset operating conditions which can be defined specifically for the particular asset type corresponding to the defined cohort. In some embodiments, the cohort baseline prediction module predicts the respective target resource baseline values.

In step 608, the computing system aggregates the respective predicted target resource baseline values. The aggregated respective predicted target resource baseline values comprise a minimum value or a maximum value of the respective target resource baseline values over a period of time. In some embodiments, the cohort baseline prediction module performs the aggregation. In some embodiments, the aggregated respective predicted target resource baseline values comprises a minimum value or a maximum value of the respective target resource baseline values over a specified period and a specified set of models associated with member assets of the cohort.

In step 610, the computing system determines a difference between the target resource baseline value of the particular asset and the aggregated respective predicted target resource baseline values (e.g., across time and space). In some embodiments, an optimization and recommendation module (e.g., optimization and recommendation module 314) determines the difference.

In step 612, the computing system causes (e.g., triggers, performs) one or more corrective actions based on the difference between the target resource baseline value of the particular asset and the aggregated respective predicted target resource baseline values. In some embodiments, the optimization and recommendation module causes the one or more corrective actions. In some embodiments, the respective predicted target resource baseline values correspond to any of an expected resource consumption or the optima among expected resource output of the assets of the cohort of assets inferred based upon the subject asset's vector of operating conditions at each point in time.

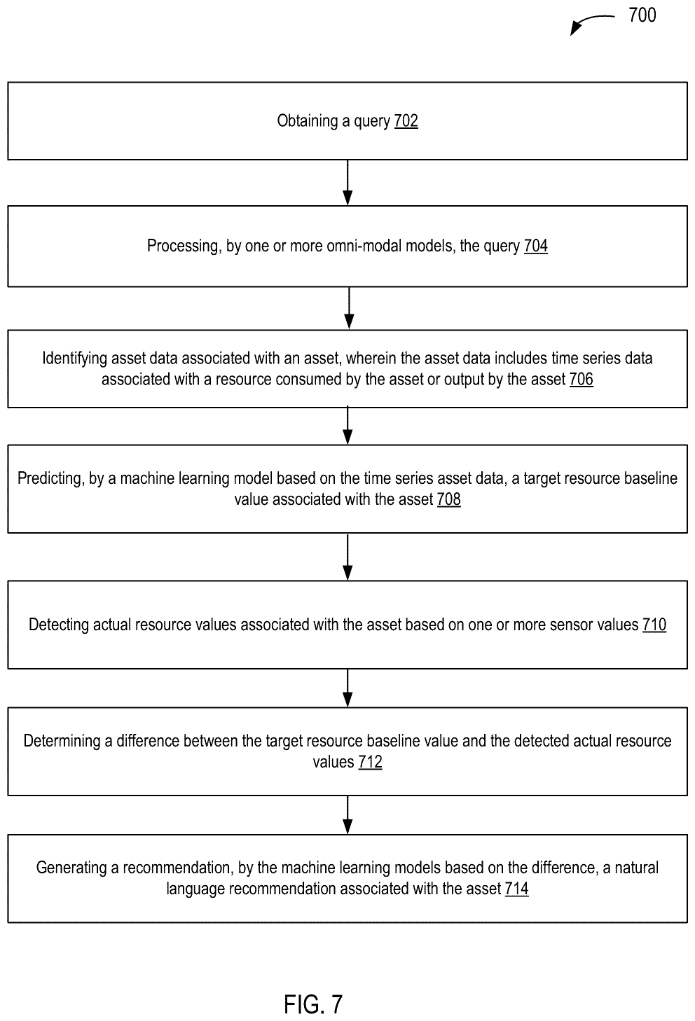

FIG. 7 depicts a flowchart 700 of an example of a method of generative artificial intelligence-based resource baseline prediction according to some embodiments. In step 702, a computing system (e.g., machine learning-based resource prediction and optimization system 102) obtains a query and/or other input. For example, the query may be a natural language query. The query may be received by a user and/or other system. In some embodiments, a communication module (e.g., communication module 340) obtains the query. In step 704, the computing system processes, by one or more omni-modal models, the query. In some embodiments, an optimization and recommendation module (e.g., optimization and recommendation module 314) processes the query.

In step 706, the computing system identifies asset data associated with an asset, wherein the asset data includes time series data associated with a resource consumed by the asset or output by the asset. In some embodiments, a management module (e.g., management module 302) and/or the communication module obtains the asset data directly from an asset, a data source (e.g., data source 108), and/or other repositories or services (e.g., weather services). In step 708, the computing system predicts, by a machine learning model based on the time series asset data, a target resource baseline value associated with the asset. In some embodiments, a resource baseline prediction module (e.g., resource baseline prediction module 306) predicts the target resource baseline value.

In step 710, the computing system detects actual resource values associated with the asset based on one or more sensor values. In some embodiments, a sensor detection module (e.g., sensor detection module 304) detects the actual resource values. In step 712, the computing system determines a difference between the target resource baseline value and the detected actual resource values. In some embodiments, the optimization and recommendation module determines the difference. In step 714, the computing system generates a recommendation, by the machine learning models based on the difference, a natural language recommendation associated with the asset. In some embodiments, the recommendation is generated based on the difference and a unified knowledge base including timeseries data, relational and unstructured text data spanning data sources such as asset telemetry, hierarchy, and/or machine documentation. The recommendations may include a recommendation to perform one or more corrective actions. In some embodiments, the optimization and recommendation module uses generative artificial intelligence models (e.g., omni-modal model) and/or methodologies to generate the natural language recommendation.

In some embodiments, the machine learning model is trained on production data associated with the asset, and the production data is structured by a model driven architecture. The recommendation can be generated as a natural language response to the query by one or more omni-modal models. Some or all of the steps 706-714 may be performed in response to step 704.

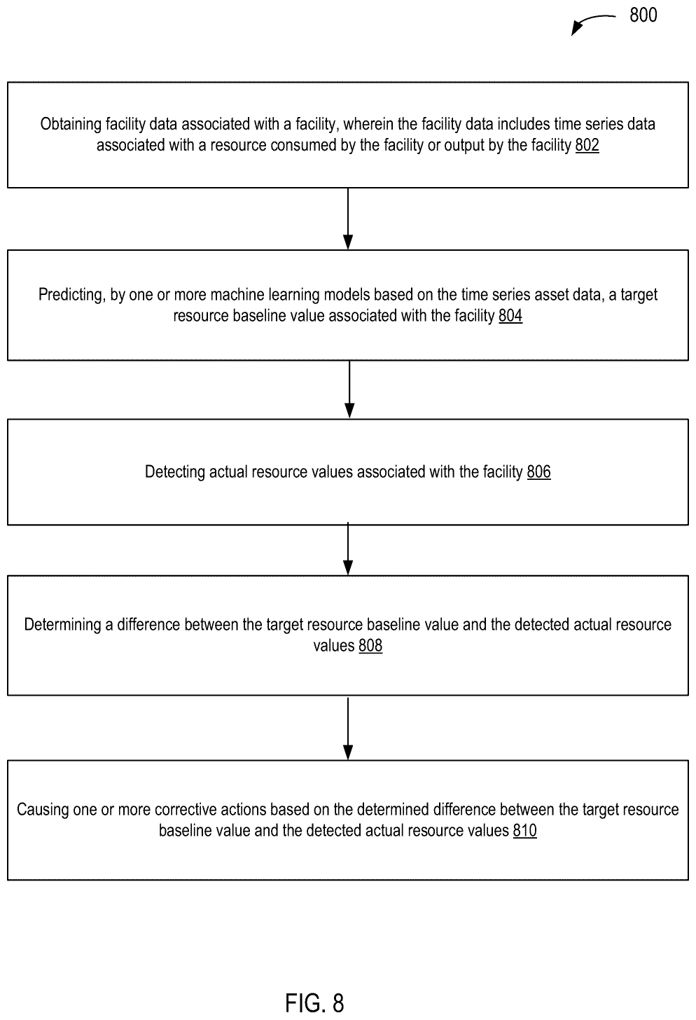

FIG. 8 depicts a diagram 800 of an example method of machine learning-based resource prediction and optimization at the facility-level according to some embodiments. In step 802, a computing system (e.g., machine learning-based resource prediction and optimization system 102) obtains facility data associated with a facility (e.g., facility 103). The facility data may include time series data associated with a resource consumed by the facility or output by the facility. In some embodiments, a management module (e.g., management module 302) and/or a communication module (e.g., communication module 340) obtains the facility data directly from the facility and/or asset(s) of the facility, a data source (e.g., data source 108), and/or other repositories or services (e.g., weather services).

In step 804, the computing system predicts, by one or more machine learning models based on the time series asset data, a target resource baseline value associated with the facility. In some embodiments, a resource baseline prediction module (e.g., resource baseline prediction module 306) performs the prediction. In step 806, the computing system detects actual resource values associated with the facility. In some embodiments, a sensor detection module (e.g., sensor detection module 304) performs the detection. For example, the sensor detection module may communicate with facility and/or assets of the facility to detect the actual resource values. In step 808, the computing system determines a difference between the target resource baseline value and the detected actual resource values. In some embodiments, an optimization and recommendation module (e.g., optimization and recommendation module 314) determines the difference.

In step 810, the computing system causes one or more corrective actions based on the determined difference between the target resource baseline value and the detected actual resource values. For example, the corrective actions may attempt to reduce the difference and/or bring the facility and/or assets in compliance with a standards protocol. In some embodiments, the optimization and recommendation module causes (e.g., triggers) the one or more corrective actions.

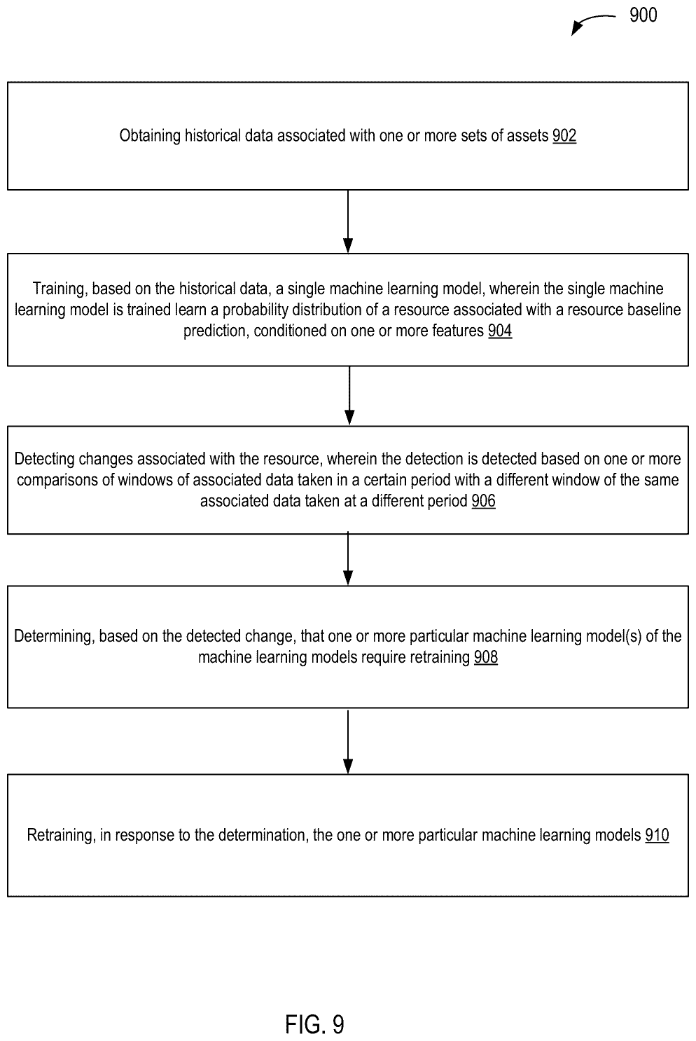

FIG. 9 depicts a flowchart 900 of an example of a method of training a machine learning model for resource baseline prediction according to some embodiments. In step 902, a computing system (e.g., machine learning-based resource prediction and optimization system 102) obtains historical data associated with one or more sets of assets. In some embodiments, a management module (e.g., management module 302) and/or a communication module (e.g., communication module 340) obtains the data directly from the facility and/or asset(s) of the facility, data source(s) (e.g., data source 108), and/or other repositories or services (e.g., weather services).

In step 904, the computing system trains, based on the historical data, a single machine learning model, wherein the single machine learning model is trained learn a probability distribution of a resource associated with a resource baseline prediction, conditioned on one or more features. In some embodiments, the models are trained using diverse datasets, such as future-known continuous data, future-known categorical data, future-unknown continuous data, and future-unknown categorical data (e.g., that correlate with electricity usage). In some embodiments, a machine learning model training module (e.g., machine learning model training module 320) trains the single machine learning model.

In 906, the computing system detects changes associated with the resource. The detection may be based on one or more comparisons of windows of associated data taken in a certain period with a different window of the same associated data taken at a different period. In some embodiments, an optimization and recommendation module (e.g., optimization and recommendation module 314) detects the changes. In step 908, the computing system determines, based on the detected change, that one or more particular machine learning models of the machine learning models require retraining and/or refining (or are recommended to be retrained and/or retrained). The machine learning model training module performs the determination of retraining and refining. In step 910, the computing system retrains and/or refines, in response to the determination, the one or more particular machine learning models. In some embodiments, the machine learning model training module retrains and/or refines the models.

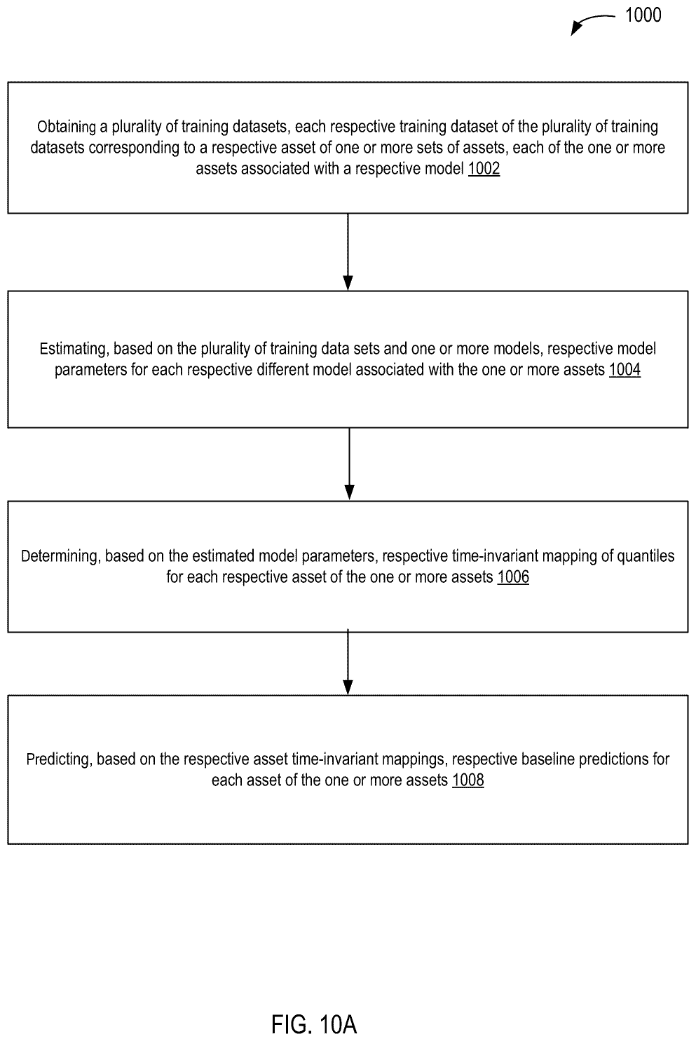

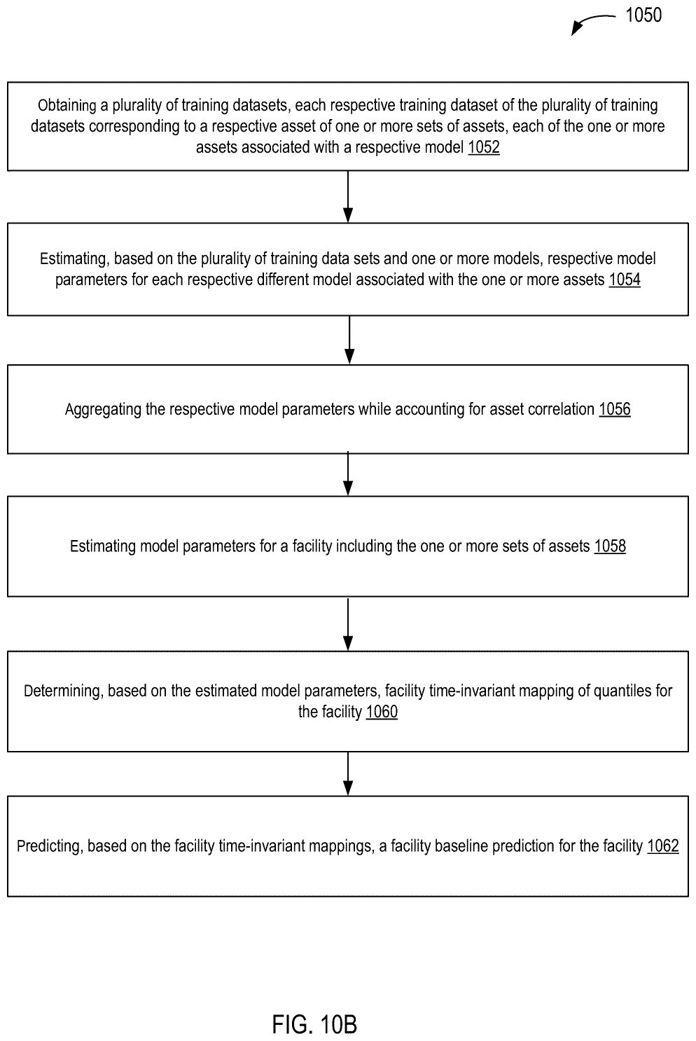

FIG. 10A depicts a flowchart 1000 of an example of a method of hierarchical aggregation to generate accurate results at the asset level when there are different types of assets and/or dependencies according to some embodiments. In step 1002, a computing system (e.g., machine learning-based resource prediction and optimization system 102) obtains a plurality of training datasets. Each respective training dataset of the plurality of training datasets may correspond to a respective asset of one or more sets of assets. Each of the one or more assets may be associated with a respective model. In some embodiments, a hierarchical aggregation module (e.g., hierarchical aggregation module 326) obtains the training datasets.

In step 1004, the computing system estimates, based on the plurality of training data sets and one or more models, respective model parameters for each respective different model associated with the one or more assets. In some embodiments, the hierarchical aggregation module estimates the model parameters. In step 1006, the computing system determines, based on the estimated model parameters, respective time-invariant mapping of quantiles for each respective asset of the one or more assets. In some embodiments, the hierarchical aggregation module 326 determines the time-invariant mapping of quantiles.

In step 1008, the computing system predicts, based on the respective asset time-invariant mappings, respective baseline predictions for each asset of the one or more assets. In some embodiments, a resource baseline prediction module (e.g., resource baseline prediction module 306) predicts the baselines. For example, the hierarchical aggregation module may cooperate with the resource baseline prediction module to predict the baselines (e.g., the hierarchical aggregation module may trigger the resource baseline prediction module to generate the prediction). It will be appreciated that the method may also be applied to facilities instead of, or in addition to, assets.

FIG. 10B depicts a flowchart 1050 of an example of a method of hierarchical aggregation to generate accurate results at the facility level when there are different types of assets and/or dependencies according to some embodiments. In step 1052, a computing system (e.g., machine learning-based resource prediction and optimization system 102) obtains a plurality of training datasets. Each respective training dataset of the plurality of training datasets may correspond to a respective asset of one or more sets of assets. Each of the one or more assets may be associated with a respective model. In some embodiments, a hierarchical aggregation module (e.g., hierarchical aggregation module 326) obtains the training datasets.

In step 1054, the computing system estimates, based on the plurality of training data sets and one or more models, respective model parameters for each respective different model associated with the one or more assets. In some embodiments, the hierarchical aggregation module estimates the model parameters. In step 1056, the computing system aggregates the respective model parameters while accounting for asset correlation. In some embodiments, the hierarchical aggregation module 326 aggregates the model parameters.

In step 1058, the computing system estimates model parameters for a facility including the one or more sets of assets. In some embodiments, the hierarchical aggregation module 326 estimates the model parameters. In step 1060, the computing system determines, based on the estimated model parameters, facility time-invariant mapping of quantiles for the facility. In some embodiments, the hierarchical aggregation module 326 determines the facility time-invariant mapping of quantiles for the facility. In step 1062, the computing system predicts, based on the facility time-invariant mappings, a facility baseline prediction for the facility. In some embodiments, a resource baseline prediction module (e.g., resource baseline prediction module 306) predicts the facility baseline prediction.

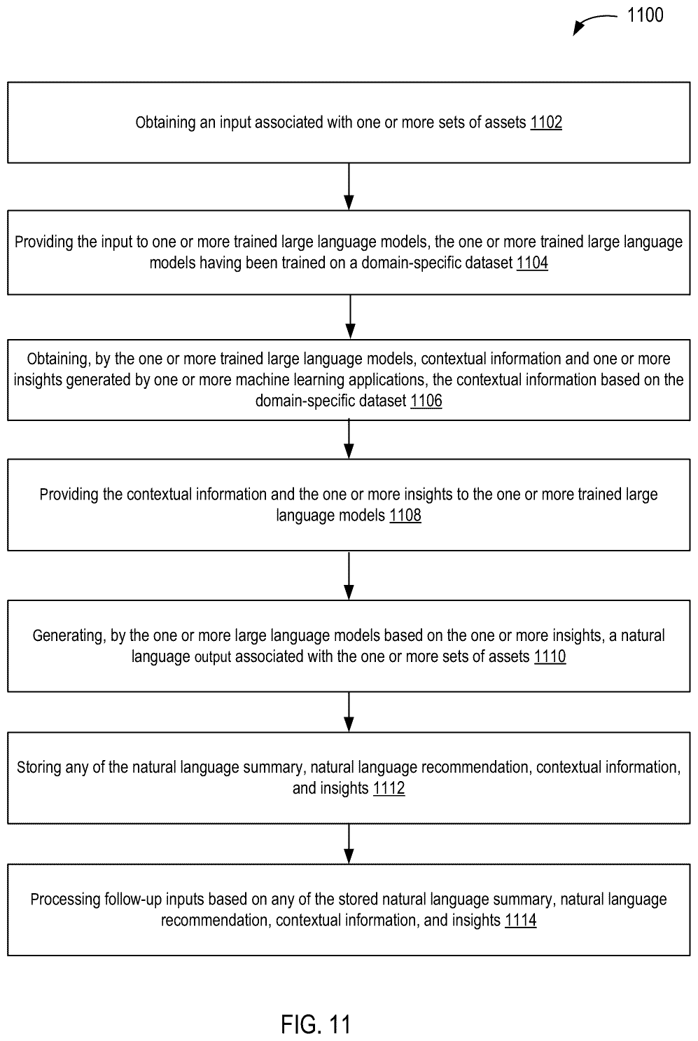

FIG. 11 depicts a flowchart 1100 of an example of a method of generative artificial intelligence-based resource prediction and optimization according to some embodiments. In step 1102, a computing system (e.g., machine learning-based resource prediction and optimization system 102) obtains an input (e.g., natural language query) associated with one or more sets of assets. In some embodiments, an interface module (e.g., interface module 332) obtains the input.

In step 1104, the computing system provides the input to one or more trained omni-modal models. The one or more trained omni-modal models may have been trained on a domain-specific dataset. In some embodiments, the interface module provide the input to one or more trained omni-modal models of an optimization and recommendation module (e.g., optimization and recommendation module 314). In step 1106, the computing system obtains, by the one or more trained omni-modal models, contextual information and one or more insights generated by one or more machine learning applications. The contextual information may be based on the domain-specific dataset. In some embodiments, the optimization and recommendation module obtains the contextual information and insights.

In step 1108, the computing system provides the contextual information and the one or more insights to the one or more trained omni-modal models. In some embodiments, the optimization and recommendation module 314 provides the contextual information and the insights to the trained models. In step 1110, the computing system generates, by the one or more omni-modal models based on the one or more insights, a natural language output. The natural language output may a natural language recommendation (e.g., of one or more corrective actions associated with the one or more sets of assets) and/or natural language summary (e.g., summary of expected and optimal resource consumption or output, summary of a predicted efficiency, etc.). In some embodiments, the optimization and recommendation module generates the natural language output.

In step 1112, the computing system stores the natural language output, the contextual information, and/or the insights. In some embodiments, a management module (e.g., management module 302) stores the natural language output in a data source (e.g., data source 108 and/or data store 350). In step 1114, the computing system processes follow-up inputs based on the stored natural language output, the contextual information, and the insights. For example, steps 1104-1110 may be repeated any number of times for any number of follow-up inputs. In some embodiments, the optimization and recommendation module processes the follow-up inputs.

In the flowcharts and/or sequence diagrams described herein, the flowcharts illustrate by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included can be removed but may have been included for the sake of illustrative clarity.

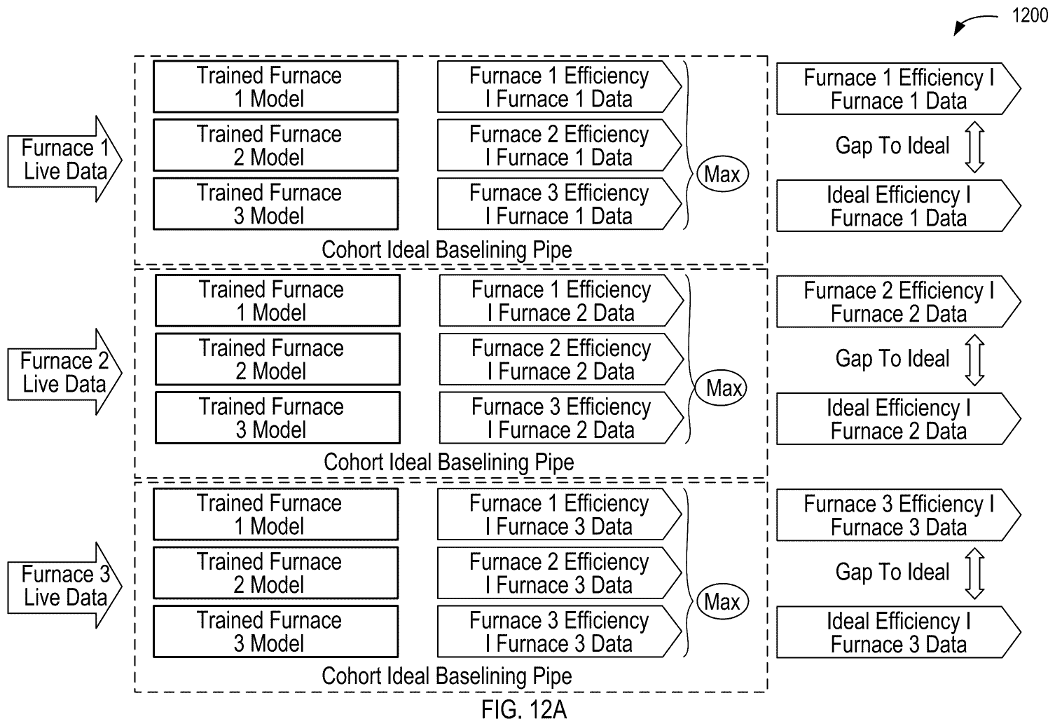

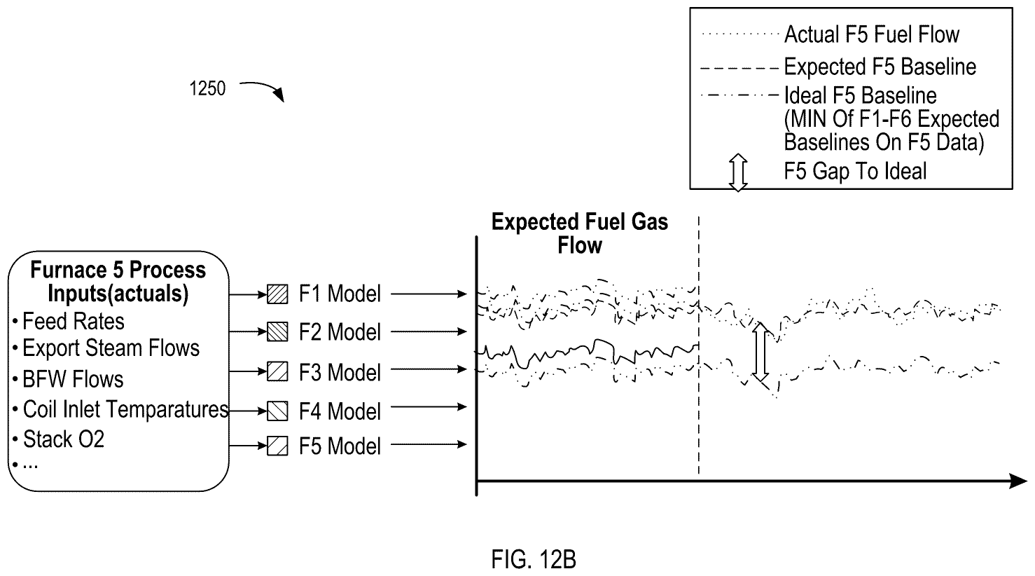

FIG. 12A depicts a diagram 1200 of example cohort baselining pipelines according to some embodiments. In the example of FIG. 12A, the pipelines includes a cohort ideal baselining pipe using furnace 1 live data as model inputs for a trained furnace 1 model, a trained furnace 2 model, and a trained furnace 3 model. The model outputs are aggregated (e.g., determine maximum ideal value from the different ideal values), and a gap between the ideal efficiency of the using furnace 1 data is determined.

The pipelines further include a cohort ideal baselining pipe using furnace 2 live data as model inputs for the trained furnace 1 model, the trained furnace 2 model, and the trained furnace 3 model. The model outputs are aggregated (e.g., determine maximum ideal value from the different ideal values), and a gap between the ideal efficiency of the using furnace 2 data is determined. The pipelines further include a cohort ideal baselining pipe using furnace 3 live data as model inputs for the trained furnace 1 model, the trained furnace 2 model, and the trained furnace 3 model. The model outputs are aggregated (e.g., determine maximum ideal value from the different ideal values), and a gap between the ideal efficiency of the using furnace 3 data is determined.

FIG. 12B depicts a diagram 1250 of example system flow and output that uses machine learning-predicted target (e.g., ideal or optimal) baseline values for asset performance benchmarking relative to asset peers. In the example of FIG. 12B, furnace 5 inputs are provided to five different trained models. Each of the trained models is specific to a particular asset (e.g., furnace 1, furnace 2, furnace 3, furnace 4, and furnace 5). The model outputs are aggregated (e.g., minimum of expected baseline using the furnace 5 data). A gap is determined between the aggregated output and the actual furnace 5 fuel flow and/or expected furnace 5 predicted baseline value. The ideal baselining capability generates an ideal baseline for an asset using the baselined performance of other assets within the same asset cohort, where each value in the ideal baseline is the optimum—typically, the minimum—across the expected values generated by peer assets' baseline models (belonging to studied asset's cohort) inferred from the studied asset's vector of operating conditions at each given timestamp. This process can be used to determine a minimum expected fuel gas flow that the peer furnaces would generate given the furnace 5 input parameters. One can understand how this approach is differentiated from prior art benchmarking methods which do not fully consider, if at all, the high dimensional vector space of asset operating conditions when comparing performance among assets. As such, prior art benchmarking methods surface false reduction or conservation opportunities that are rejected by engineers or operators, who recognize that material variables were overlooked during opportunity identification. The cohort baseline module offers the ability to completely automate and rapidly prioritize correctly validated opportunities across an enterprise's entire fleet of assets, a task requiring superhuman intelligence and comprehensive, end-to-end automation lacking in prior art systems.

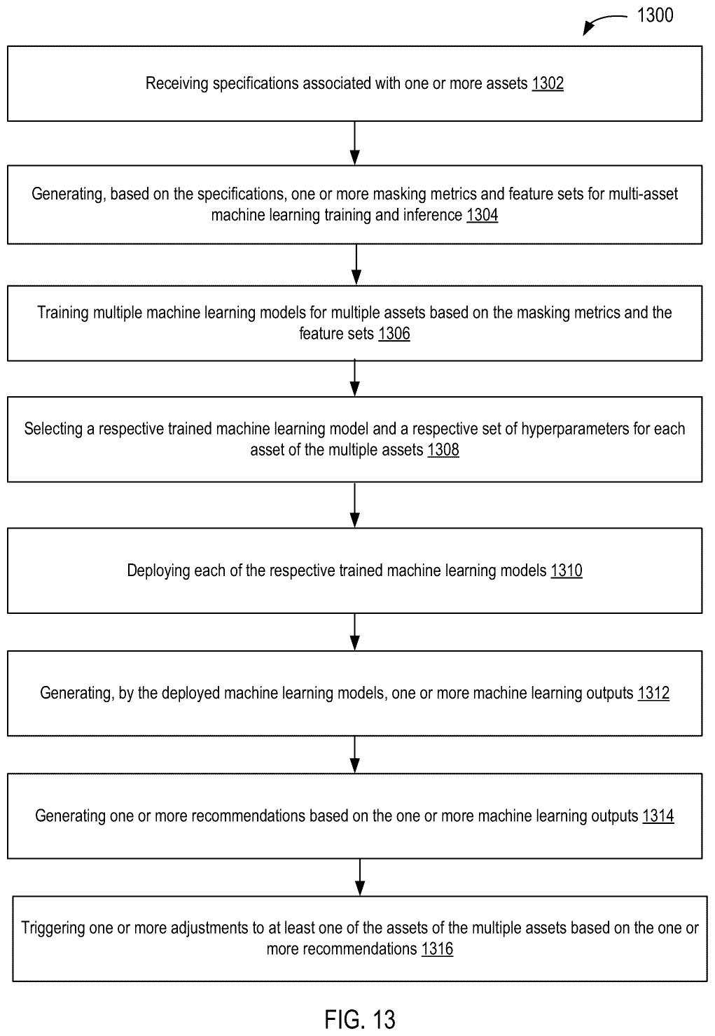

FIG. 13 depicts a flowchart 1300 of an example of a method of operation of an orchestrator module according to some embodiments. In step 1302, an orchestrator module (e.g., orchestrator module 322) receives specifications (e.g., user specifications, asset specifications, facility specifications) associated with one or more assets. In step 1304, the orchestrator module generates, based on the specifications, one or more masking metrics and feature sets for multi-asset machine learning training and inference. In step 1306, the orchestrator module trains multiple machine learning models for multiple assets based on the masking metrics and the feature sets. In step 1308, the orchestrator module selects a respective trained machine learning model and a respective set of hyperparameters for each asset of the multiple assets.

In step 1310, the orchestrator module deploys each of the respective trained machine learning models. In step 1312, the orchestrator module generates, by the deployed machine learning models, one or more machine learning outputs. In step 1314, the orchestrator module generates one or more recommendations based on the one or more machine learning outputs. In step 1316, the orchestrator module causes (e.g., triggers) one or more adjustments to at least one of the assets of the multiple assets based on the one or more recommendations.

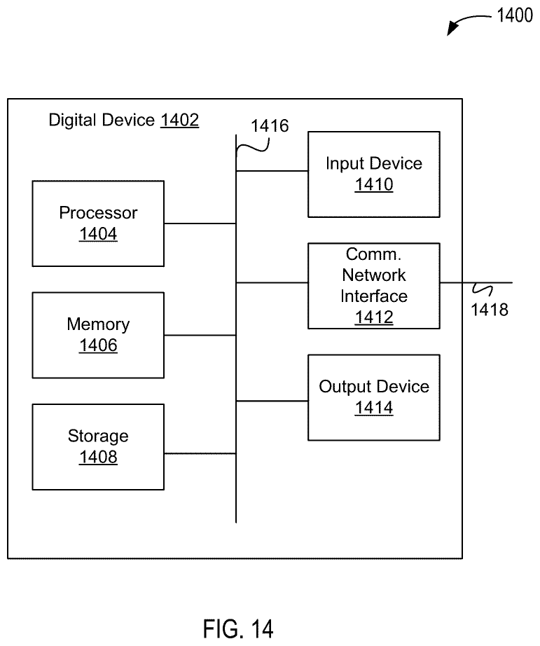

FIG. 14 depicts a diagram 1400 of an example of a computing device 1402. Any of the systems, engines, datastores, and/or networks described herein may comprise an instance of one or more computing devices 1402. In some embodiments, functionality of the computing device 1402 is improved to the perform some or all of the functionality described herein. The computing device 1402 comprises a processor 1404, memory 1406, storage 1408, an input device 1410, a communication network interface 1412, and an output device 1414 communicatively coupled to a communication channel 1416. The processor 1404 is configured to execute executable instructions (e.g., programs). In some embodiments, the processor 1404 comprises circuitry or any processor capable of processing the executable instructions.

The memory 1406 stores data. Some examples of memory 1406 include storage devices, such as RAM, ROM, RAM cache, virtual memory, etc. In various embodiments, working data is stored within the memory 1406. The data within the memory 1406 may be cleared or ultimately transferred to the storage 1408. The storage 1408 includes any storage configured to retrieve and store data. Some examples of the storage 1408 include flash drives, hard drives, optical drives, cloud storage, and/or magnetic tape. Each of the memory system 1406 and the storage system 1408 comprises a computer-readable medium, which stores instructions or programs executable by processor 1404.

The input device 1410 is any device that inputs data (e.g., mouse and keyboard). The output device 1414 outputs data (e.g., a speaker or display). It will be appreciated that the storage 1408, input device 1410, and output device 1414 may be optional. For example, the routers/switchers may comprise the processor 1404 and memory 1406 as well as a device to receive and output data (e.g., the communication network interface 1412 and/or the output device 1414). The communication network interface 1412 may be coupled to a network (e.g., network 112) via the link 1418. The communication network interface 1412 may support communication over an Ethernet connection, a serial connection, a parallel connection, and/or an ATA connection. The communication network interface 1412 may also support wireless communication (e.g., 802.11 a/b/g/n, WiMax, LTE, WiFi). It will be apparent that the communication network interface 1412 may support many wired and wireless standards.

It will be appreciated that the hardware elements of the computing device 1402 are not limited to those depicted in FIG. 14. A computing device 1402 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1404 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In general, the routines executed to implement the embodiments of the present disclosure can be implemented as part of an operating system or a specific application, component, program, object, module or sequence of instructions referred to as “programs” or “applications”. For example, one or more programs or applications can be used to execute specific processes described herein. The programs or applications typically comprise one or more instructions set at various times in various memory and storage devices in the machine and that, when read and executed by one or more processors, cause the machine to perform operations to execute elements involving the various aspects of the embodiments described herein.

Example types of processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

Example embodiments of the resource target baseline prediction machine learning systems and methods disclosed herein can be used with AI decision-making optimization applications. In some example implementations resource target baseline prediction machine learning modeling can be used with a model-driven architecture that includes a type system.

A model-driven architecture is a term for a software design approach that provides models as a set of guidelines for structuring specifications. An example model-driven architecture may include a type system that may be used as a domain-specific language (DSL) within a platform used to access data, interact with data, and/or perform processing or analytics based on one or more type or function definitions within the type system. By using an abstraction layer provided by a type system, the complexity of a logistics optimization application problem can be reduced by orders of magnitude, such as to the order of a few thousand types, for any given logistics optimization application that a programmer manipulates using JAVASCRIPT or other language to achieve a desired result. Thus, all of the complexity of the underlying foundation (with an order of M×S×T×A×U using structured programming paradigms) is abstracted and simplified for the programmer. Here, M represents the number of process modules (APACHE Open Source modules are examples of process modules), S represents the number of disparate enterprise and extraprise data sources, T represents the number of unique sensored devices, A represents the number of programmatic APIs, and U represents the number of user presentations or interfaces. Example technologies that can be included in one or more embodiments may include nearly-free and unlimited compute capacity and storage in scale-out cloud environments, such as AMAZON Web Services (AWS); big data and real-time streaming; smart connected devices; mobile computing; and data science including big-data analytics and machine learning to process the volume, velocity, and variety of big-data streams.

The type system of the model-driven architecture may include types as data objects and at least one of: associated methods, associated logic, and associated machine learning classifiers. One or more of the data objects may be associated with at least one of: one or more customers, one or more companies, one or more accounts, one or more products, one or more employees, one or more suppliers, one or more opportunities, one or more contracts, one or more locations, and one or more digital portals. Type definitions may include properties or characteristics of an implemented software construct.

Employing the type system of the model-driven architecture may include performing data modeling to translate raw source data formats into target types. Sources of data may be associated with at least one of: accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, and service logs. Among other things, the type system can be employed to perform data modeling in order to translate raw source data formats into target types. Sources of data for which data modeling and translation can be performed may include accounts, products, employees, suppliers, opportunities, contracts, locations, digital portals, geolocation manufacturers, SCADA information, OMS information, inventories, supply chains, bills of materials, transportation services, maintenance logs, or service logs.

The model-driven architecture enables capabilities and applications including precise predictive analytics, massively parallel computing at the edge of a network, and fully-connected sensor networks at the core of a business value chain. The model-driven architecture can serve as the nerve center that connects and enables collaboration among previously-separate business functions, including product development, marketing, sales, service support, manufacturing, inventory, finance, shipping, order management, human capital management, etc. Some embodiments may include a product cloud that includes software running on a hosted elastic cloud technology infrastructure that stores or processes product data, customer data, enterprise data, and Internet data. The product cloud may provide one or more of: a platform for building and processing software applications; massive data storage capacity; a data abstraction layer that implements a type system; a rules engine and analytics platform; a machine learning engine; smart product applications; and social human-computer interaction models. One or more of the layers or services may depend on the data abstraction layer for accessing stored or managed data, communicating data between layers or applications, or otherwise storing, accessing, or communicating data.

The model-driven architecture may operate as a comprehensive design, development, provisioning, and operating platform for industrial-scale applications in various industries, such as energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

An integration component, data services component, and modular services component may store, transform, communicate, and process data based on the type system. In some embodiments, the data sources and/or the applications may also operate based on the type system. In an example embodiment, the applications may be configured to operate or interface with the components based on the type system. For example, the applications may include business logic written in code and/or accessing types defined by a type system to leverage services provided by the system.

In some embodiments, the model-driven architecture uses a type system that provides type-relational mapping based on a plurality of defined types. For example, the type system may define types for use in the applications, such as a type for a customer, organization, device, or the like. During development of an application, an application developer may write code that accesses the type system to read or write data to the system, perform processing or business logic using defined functions, or otherwise access data or functions within defined types. In some embodiments, the model-driven architecture enforces validation of data or type structure using annotations/keywords. The types in the type system may include defined view configuration types used for rendering type data on a screen in a graphical, text, or other format. In some embodiments, a server, such as a server that implements at least a portion of the system, may implement mapping between data stored in one or more databases and a type in the type system, such as data that corresponds to a specific customer type or other type.

One example of a type system is given by way of the following non-limiting example, which may be used in various embodiments and in combination with any other teachings of this disclosure. In some embodiments, the fundamental concept in the type system is a “type,” which is similar to a “class” in object-oriented programming languages. At least one difference between “class” in some languages and “type” in some embodiments of the type system disclosed here is that the type system is not tied to any particular programming language. As discussed here, at least some embodiments disclosed here include a model-driven architecture, where types are the models. Not only are types interfaces across different underlying technologies, but they are also interfaces across different programming languages. In fact, the type system can be considered self-describing, so below is presented an overview of the types that may define the type system itself.

A type is the definition of a potentially-complex object that the system understands. Types may be the primary interface for all platform services and the primary way that application logic is organized. Some types are defined by and built into the platform itself. These types provide a uniform model across a variety of underlying technologies. Platform types also provide convenient functionality and build up higher-level services on top of low-level technologies. Other types are defined by the developers using the platform. Once installed in the environment, they can be used in the same ways as the platform types. There is no sharp distinction between types provided by the platform and types developed using the platform.

The logistics optimization application can be used with various enterprise functions, such as messaging, reporting, alerting, etc. processes to update systems based on triggers, detecting anomalies, real-time data streams, etc. In example enterprise environments, the logistics optimization application can control or instruct manufacturing or resource planning systems.

Aspects of this disclosure can be used with an Enterprise Generative AI framework for unifying information access methodologies and application operations across legacy and new enterprise applications and growing magnitude of data sources in enterprise environments. Example implementations with an Enterprise Generative AI framework can enable harmonizing access to information and increasing availability to complex application operations while respecting enterprise security and privacy controls. The framework can use machine learning techniques to navigate enterprise information and applications, comprehend organization specific context queues (e.g., acronyms, nicknames, jargon, etc.), and locate information most relevant to a request. Example implementations can be used to lower the learning curve and reduce the steps a user must perform to access information thereby democratizing usage of information currently blocked by complexities and domain expertise required by conventional enterprise information systems.

In some embodiments, resource target baseline prediction machine learning techniques can be used to enable an intuitive non-complex interface to rapidly execute complex user requests with improved access, privacy, and security enforcement. Implementations leverage generative AI techniques to enable responses to requests that are provided to users in an intuitive, non-complex manner. An example Enterprise Generative AI framework can include a human computer interface for receiving natural language queries and presenting relevant information with predictive analysis from the enterprise information environment in response to the queries. An enterprise comprehension module is used to understand the language, intent, and context of a user natural language query. The enterprise comprehension module executes the user natural language query to discern relevant information from the enterprise information environment to present to the human computer interface. The generative AI models interact with one or more of the one or more retrieval models. One or more retrieval models are used for understanding underlying data, documents, and applications of an enterprise information environment. Underlying data of the enterprise information environment can be embedded by an orchestration module, for example, by a model driven architecture for the conceptual representation of enterprise and external data sets for data virtualization and access control. Information presented with predictive analysis can include text summary, ranked results, smart cards, AI-powered chat interface, content generated on-the-fly, etc. The predictive analysis can be from one or more AI applications that include, for example, Supply Chain, CRM, ERP, Reliability, Defense, Sustainability, or Energy, etc.

Resource target baseline prediction machine learning techniques provides transformative practical solutions for optimizing complex problems. Input can be from enterprise users using a natural language interface to rapidly locate, retrieve, and present relevant data across the entire corpus of an enterprise's information systems. Synthetic data or new content generation can refer to content generated on-the-fly as part of the request response. Synthetic data can also include non-retrieved ephemeral content (e.g., temporary data that does not subsist in a database), as well as combinations of retrieved, queried information, model output, etc.

As used herein, AI applications can include, for example, Supply Chain, CRM, ERP, Reliability, Defense, Sustainability, Energy, etc. AI applications can be capable of processing data pertaining to a real-world systems, devices, scenarios, etc. and analyze the data to derive one or more insights. Generative AI, for example, can aid enterprise logistics operations with logistical uncertainty, such as an inventory module, a prediction module, a simulation module, a tuning module, an optimization module, an aggregation module, an automation module, a control module, etc. An example framework for integrating, processing, and abstracting data related to an enterprise logistics optimization development platform can include tools for machine learning, application development and deployment, data visualization, automated control and instruction, other tools (such as an integration component, a data services component, a modular services component, and an application that may be located on or behind an application module), etc. Enterprise Generative AI aids designing, development, provisioning, and operating a platform for industrial-scale applications in various industries, such as energy industries, health or wearable technology industries, sales and advertising industries, transportation industries, communication industries, scientific and geological study industries, military and defense industries, financial services industries, healthcare industries, manufacturing industries, retail, government organizations, and/or the like. The system may enable integration and processing of large and highly dynamic data sets from enormous networks and large-scale information systems.

For example, supply chain data may be obtained from a first AI application (e.g., an inventory management and optimization or supply chain application) and the impact information may be obtained based at least in part on the supply chain data and information from another AI application, such as an AI application used to monitor and predict maintenance needs for a fleet of vehicles. In the example, the supply chain data may indicate issues with the supply, another AI application may be used to identify vehicles needing maintenance, and the impact information may represent an insight into how the vehicles needing maintenance are being impacted by issues in the supply chain (e.g., based on the supply chain data). Example information from different data domains or application objects may include key performance metrics (KPIs) (e.g., from left to right—a fleet readiness score, unscheduled maintenance avoided (hours) over a time period, a number of flights gained (e.g., due to avoided maintenance), operation time at risk, etc.), aircraft status risk score information, component risk score and ranking (by risk score) information, information associated with AI alerts, flight capability information (e.g., by geographic region), case information, supply chain data, and impact information regarding aircraft being impacted by effects within the supply chain. The ability to obtain insights from one or more AI applications and return those insights provides enhanced accessibility functionality. For example, the impact information may not be obtained from a supply chain application or maintenance application individually.

The outputs can include predictions, insights, or recommendations from the associated AI applications and be in the form of dispatching actions, decision support guidance, inter-platform instruction generation, dynamic dashboard, automated summary charts of critical information, access AI-generated summary answers with references to sources, email briefs, alerts, generic content generation (e.g., proposals), an AI-powered chat interface, ranked list of top results, etc. from the one or more AI applications, open source libraries, document libraries, email systems, etc.

Resource target baseline prediction machine learning techniques may leverage the capabilities of different AI applications to return insights based on outputs of multiple AI applications. It can be used with an Enterprise Generative AI system to provide a powerful new capabilities using a single interface with intelligent interactive features (e.g., chatbot) to recommend actions based on the response to the query. In an example, the retrieval AI model with HCl proposes or responds to workflow tasks/actions via a chatbot interaction that includes generating new recommendations or workflows based on context of a request and/or knowledge base resources. For example, a supply chain request about ‘from which location can I get an xyz engine to Guam?’, the Enterprise Generative AI system can create a new recommendation with a workflow and prompt “would you like to have the part sent?” to further trigger an instruction to one or more enterprise applications or information systems. Various responsive context based dispatching actions, recommendations, or tasks/actions can be created (e.g., e-mails, order/inventory management, maintenance, etc.) and dynamic interface generation responsive to workflow-related search results (i.e., launch e-mail application with data populated in body of e-mail related to or derived from search as part of workflow; display workflow on dynamic web page responsive to activation of workflow search results element, etc.). The interaction elements can include predictions, insights, or recommendations from the associated AI applications and be in the form of, for example, dispatching actions, decision support guidance, inter-platform instruction generation, etc. from the one or more AI applications, open source libraries, document libraries, email systems, etc.

A request can be input various natural forms for easy human interaction (e.g., basic text box interface, image processing, voice activation, etc.) and processed to rapidly find the relevant and responsive information. Enterprise Generative AI summarizes the relevant comprehensive answers (e.g., text summary, ranked results, smart cards, etc.), generates new insight content, and presents interactive results for users in a transparent manner. For example, each request response can include a list of search results ranked by relevance—across documents, web pages, and applications. Enterprise Generative AI can be used to manage all relevant access-controls and enterprise security requirements to ensure that users are only able to see the documents and results that they have the permissions to access and view. With both cloud-native and air-gapped deployment availability, Enterprise Generative AI addresses unique security and scalability requirements across a wide range of industries and use cases. Enterprise Generative AI can be deployed as part of a stand-alone application and/or integrated into existing enterprise applications and platforms, including for example, C3 AI Platform or with C3 AI applications such as C3 AI Reliability, C3 AI Supply Chain, C3 AI Sustainability, C3 AI CRM, C3 AI ERP, C3 AI Defense, C3 AI Energy, among others.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform obtaining asset data associated with an asset, wherein the asset data includes time series data associated with a resource consumed by the asset or output by the asset to serve as a target variable to baseline; predicting, by a machine learning model based on the time series asset data, a target resource baseline value associated with the asset based upon the asset's operating conditions; detecting actual resource values associated with the asset based on one or more sensor values; and determining a recommendation based on a difference between the target resource baseline value and the actual resource values for the target variable.

In some embodiments, the target resource baseline value corresponds to any of an expected resource consumption of the asset and an optimal resource consumption of the asset. In some embodiments, the target resource baseline value corresponds to any of an expected resource output of the asset and an optimal resource output of the asset. In some embodiments, the actual resource values include real-time time series values associated with the resource consumed or output by the asset, and the target resource values comprise time series values. In some embodiments, the resource comprises any of greenhouse gas emissions, electricity consumption or generation, combusted fuels, water, waste, and compressed air, derived resources, and other metrics informing operational or sustainability performance.

The systems, methods, and non-transitory computer-readable medium (or media) may be further configured to perform simulating an adjustment to the asset; predicting an outcome of the simulation using one or more additional machine learning models; and generating one or more instructions to adjust the asset based on a comparison of the predicted outcome and a threshold value.

The systems, methods, and non-transitory computer-readable medium (or media) may be further configured to perform detecting degradation of the asset based on the difference between the target resource baseline value and the detected actual resource values over a period.

The systems, methods, and non-transitory computer-readable medium (or media) may be further configured to perform predicting, based on one or more additional machine learning models and the detected actual resource values, a future resource value associated with the asset; determining, based on a comparison of the future resource value and the predicted target resource value, a corrective action; and causing (e.g., triggering) an adjustment to the asset based on the corrective action.

The systems, methods, and non-transitory computer-readable medium (or media) may be further configured to perform determining, based on the difference between the predicted resource baseline value and the detected actual resource values, a potential resource reduction or increase associated with the asset and the resource.

The systems, methods, and non-transitory computer-readable medium (or media) may be further configured to perform tracking a reduction or increase of the detected resource consumption or output over a period of time against the potential resource reduction or increase associated with the asset and the resource; and determining one or more corrective actions based on the tracking.

In some embodiments, the predicted target resource baseline value comprises time series data values predicted over a period of time.

The systems, methods, and non-transitory computer-readable medium (or media) may be further configured to perform masking a portion of the asset data, wherein the target resource baseline value is predicted based on the asset data excluding the masked portion of the asset data.

The systems, methods, and non-transitory computer-readable medium (or media) may be further configured to perform obtaining other asset data associated with the multiple assets, wherein the other asset data includes other time series data associated with a resource consumed by the other assets of the multiple assets or output by the other assets to serve as other target variables to baseline; predicting other target resource baseline values for each of the other assets of the multiple based upon the other asset's operating conditions; detecting other actual resource values associated with the other assets based on one or more other sensor values; and determining another recommendation based on differences between the other target resource baseline values of the other assets and the other actual resource values. The systems, methods, and non-transitory computer-readable medium (or media) may be further configured to perform providing the recommendation to the asset (and/or a production controller associated with the asset), thereby causing an adjustment to the asset.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform determining a cohort of assets; obtaining asset data associated with a particular asset of the cohort of assets, wherein the asset data includes time series data associated with a resource consumed by the asset or output by the asset; predicting, for each asset of the cohort of assets, a respective target resource baseline value, wherein each of the respective target resource baseline values is predicted by a different machine learning model based on the asset data associated with the particular asset of the cohort of assets; aggregating the respective predicted target resource baseline values; and determining a difference between the target resource baseline value of the particular asset and the aggregated respective predicted target resource baseline values.

In some embodiments, the aggregated respective predicted target resource baseline values comprise a minimum value or a maximum value of the respective target resource baseline values over a period of time. In some embodiments, each of the different machine learning models comprises a respective machine learning model trained for a different asset of the cohort of assets. In some embodiments, the respective predicted target resource baseline values correspond to any of an expected resource consumption or expected resource output of the assets of the cohort of assets.

The systems, methods, and non-transitory computer-readable medium (or media) may be further configured to perform performing one or more corrective actions based on the difference between the target resource baseline value of the particular asset and the aggregated respective predicted target resource baseline values. In some embodiments, the asset data includes real-time time series data associated with the resource consumed or output by the cohort of assets. In some embodiments, the cohort of assets is determined based one or more similar attributes of the assets. Various embodiments of the present disclosure include systems (e.g., having one or more processors, and memory storing instructions that, when executed by the one or more processors, cause the system to perform functionality described herein), methods, and non-transitory computer-readable medium (or media) configured to perform identifying asset data associated with an asset based on a query, wherein the asset data includes time series data associated with a resource consumed by the asset or output by the asset; predicting, by a machine learning model based on the time series asset data, a target resource baseline value associated with the asset; detecting actual resource values associated with the asset based on one or more sensor values; determining a difference between the target resource baseline value and the detected actual resource values; and generating a recommendation, by the machine learning models based on the difference, a natural language recommendation associated with the asset.

In some embodiments, the recommendation is generated as a natural language response to the query by one or more omni-modal models. In some embodiments, the machine learning model is trained on production data associated with the asset, and wherein the production data is structured by a model driven architecture.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform obtaining facility data associated with a facility, wherein the facility data includes time series data associated with a resource consumed by the facility or output by the facility to serve as a target variable to baseline; predicting, by a machine learning model based on the time series facility data, a target resource baseline value associated with the facility based upon the facility's operating conditions; detecting actual resource values associated with the facility based on one or more sensor values; and determining a recommendation based on a difference between the target resource baseline value and the actual resource values for the target variable.

In some embodiments, the machine learning model is trained on the facility data, and wherein the production data is structured by a model driven architecture.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform receiving user specifications associated with one or more assets; generating, based on the specifications, one or more masking metrics and feature sets for multi-asset machine learning training and inference; training multiple machine learning models for multiple assets based on the masking metrics and the feature sets; selecting a respective trained machine learning model and a respective set of hyperparameters for each asset of the multiple assets; deploying each of the respective trained machine learning models; generating, by the deployed machine learning models, one or more machine learning outputs; and generating one or more recommendations based on the one or more machine learning outputs.

The systems, methods, and non-transitory computer-readable medium (or media) may be further configured to perform triggering one or more adjustments to at least one of the assets of the multiple assets based on the one or more recommendations.

In the flowcharts and/or sequence diagrams described herein, the flowcharts and/or sequence diagrams may illustrate by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

These and other features of the systems, methods, and non-transitory computer readable media disclosed herein, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

The present invention(s) are described above with reference to example embodiments. It will be apparent to those skilled in the art that various modifications may be made, and other embodiments may be used without departing from the broader scope of the present invention(s). Therefore, these and other variations upon the example embodiments are intended to be covered by the present invention(s).

What is claimed is:

1. A method comprising:
obtaining asset data associated with an asset, wherein the asset data includes time series data associated with a resource consumed by the asset or output by the asset to serve as a target variable to baseline;
predicting, by a machine learning model based on the time series asset data, a target resource baseline value associated with the asset based upon the asset's operating conditions;
detecting actual resource values associated with the asset based on one or more sensor values; and
determining a recommendation based on a difference between the target resource baseline value and the actual resource values for the target variable.

2. The method of claim 1, wherein the target resource baseline value corresponds to any of an expected resource consumption of the asset and an optimal resource consumption of the asset.

3. The method of claim 1, wherein the target resource baseline value corresponds to any of an expected resource output of the asset and an optimal resource output of the asset.

4. The method of claim 1, wherein the actual resource values include real-time time series values associated with the resource consumed or output by the asset, and the target resource values comprise time series values.

5. The method of claim 1, wherein the resource comprises any of greenhouse gas emissions, electricity consumption or generation, combusted fuels, water, waste, and compressed air, derived resources, and other metrics informing operational or sustainability performance.

6. The method of claim 1, further comprising:
simulating an adjustment to the asset;
predicting an outcome of the simulation using one or more additional machine learning models; and
generating one or more instructions to adjust the asset based on a comparison of the predicted outcome and a threshold value.

7. The method of claim 1, further comprising detecting degradation of the asset based on the difference between the target resource baseline value and the detected actual resource values over a period.

8. The method of claim 1, further comprising:
predicting, based on one or more additional machine learning models and the detected actual resource values, a future resource value associated with the asset;
determining, based on a comparison of the future resource value and the predicted target resource value, a corrective action; and
causing an adjustment to the asset based on the corrective action.

9. The method of claim 1, further comprising:
determining, based on the difference between the predicted resource baseline value and the detected actual resource values, a potential resource reduction or increase associated with the asset and the resource.

10. The method of claim 4, further comprising:
tracking a reduction or increase of the detected resource consumption or output over a period of time against the potential resource reduction or increase associated with the asset and the resource; and
determining one or more corrective actions based on the tracking.

11. The method of claim 1, wherein the predicted target resource baseline value comprises time series data values predicted over a period of time.

12. The method of claim 1, further comprising:
masking a portion of the asset data, wherein the target resource baseline value is predicted based on the asset data excluding the masked portion of the asset data.

13. The method of claim 1, wherein the asset comprises an asset of multiple assets, and further comprising:
obtaining other asset data associated with the multiple assets, wherein the other asset data includes other time series data associated with a resource consumed by the other assets of the multiple assets or output by the other assets to serve as other target variables to baseline;
predicting other target resource baseline values for each of the other assets of the multiple based upon the other asset's operating conditions;
detecting other actual resource values associated with the other assets based on one or more other sensor values; and
determining another recommendation based on differences between the other target resource baseline values of the other assets and the other actual resource values.

14. The method of claim 1, further comprising:
providing the recommendation to the asset, thereby causing an adjustment to the asset.

15. A method comprising:
determining a cohort of assets;
obtaining asset data associated with a particular asset of the cohort of assets, wherein the asset data includes time series data associated with a resource consumed by the asset or output by the asset;
predicting, for each asset of the cohort of assets, a respective target resource baseline value, wherein each of the respective target resource baseline values is predicted by a different machine learning model based on the asset data associated with the particular asset of the cohort of assets;
aggregating the respective predicted target resource baseline values; and
determining a difference between the target resource baseline value of the particular asset and the aggregated respective predicted target resource baseline values.

16. The method of claim 15, wherein the aggregated respective predicted target resource baseline values comprise a minimum value or a maximum value of the respective target resource baseline values over a period of time.

17. The method of claim 15, wherein each of the different machine learning models comprises a respective machine learning model trained for a different asset of the cohort of assets.

18. The method of claim 15, wherein the respective predicted target resource baseline values correspond to any of an expected resource consumption or expected resource output of the assets of the cohort of assets.

19. The method of claim 15, further comprising performing one or more corrective actions based on the difference between the target resource baseline value of the particular asset and the aggregated respective predicted target resource baseline values.

20. The method of claim 15, wherein the asset data includes real-time time series data associated with the resource consumed or output by the cohort of assets.

21. The method of claim 15, wherein the cohort of assets is determined based one or more similar attributes of the assets.

22. A method comprising:
identifying asset data associated with an asset based on a query, wherein the asset data includes time series data associated with a resource consumed by the asset or output by the asset;
predicting, by a machine learning model based on the time series asset data, a target resource baseline value associated with the asset;
detecting actual resource values associated with the asset based on one or more sensor values;
determining a difference between the target resource baseline value and the detected actual resource values; and
generating a recommendation, by the machine learning models based on the difference, a natural language recommendation associated with the asset.

23. The method of claim 22, further comprising,
wherein the recommendation is generated as a natural language response to the query by one or more omni-modal models.

24. The method of claim 22, wherein the machine learning model is trained on production data associated with the asset, and wherein the production data is structured by a model driven architecture.

25. A method comprising:
obtaining facility data associated with a facility, wherein the facility data includes time series data associated with a resource consumed by the facility or output by the facility to serve as a target variable to baseline;
predicting, by a machine learning model based on the time series facility data, a target resource baseline value associated with the facility based upon the facility's operating conditions;
detecting actual resource values associated with the facility based on one or more sensor values; and
determining a recommendation based on a difference between the target resource baseline value and the actual resource values for the target variable.

26. The method of claim 25, wherein the machine learning model is trained on the facility data, and wherein the production data is structured by a model driven architecture.

27. A method comprising:
receiving user specifications associated with one or more assets;
generating, based on the specifications, one or more masking metrics and feature sets for multi-asset machine learning training and inference;
training multiple machine learning models for multiple assets based on the masking metrics and the feature sets;
selecting a respective trained machine learning model and a respective set of hyperparameters for each asset of the multiple assets;
deploying each of the respective trained machine learning models;
generating, by the deployed machine learning models, one or more machine learning outputs; and
generating one or more recommendations based on the one or more machine learning outputs.

28. The method of claim 27, further comprising triggering one or more adjustments to at least one of the assets of the multiple assets based on the one or more recommendations.
